(19) United States
(12) Patent Application Publication
(10) Pub. No.: US 2023/0300936 A1
(43) Pub. Date: Sep. 21, 2023

(54) METHOD AND DEVICE FOR WIRELESS COMMUNICATION

(71) Applicants: Yu CHEN, Shanghai (CN); Xiaobo ZHANG, Shanghai (CN)

(72) Inventors: Yu CHEN, Shanghai (CN); Xiaobo ZHANG, Shanghai (CN)

(73) Assignee: SHANGHAI LANGBO COMMUNICATION TECHNOLOGY COMPANY LIMITED, Shanghai (CN)

(21) Appl. No.: 18/201,766

(22) Filed: May 25, 2023

Related U.S. Application Data
(63) Continuation of application No. PCT/CN2021/132051, filed on Nov. 22, 2021.

(30) Foreign Application Priority Data
Nov. 25, 2020 (CN) 202011339063.1

(51) Int. Cl. H04W 76/20

(52) U.S. Cl. CPC H04W 76/20; H04W 92/18

(57) ABSTRACT

The present application discloses a method and a device used for wireless communications, including: receiving a first radio signal and a second radio signal; the first radio signal comprising a first signaling, and the second radio signal comprising a first message; the first signaling being used to indicate a first RRC parameter group set; the first RRC parameter group set comprising Q RRC parameter groups, Q being a positive integer greater than 1, while the first message being used to determine a first RRC parameter group from the first RRC parameter group set; executing the first RRC parameter group; and transmitting a second message; the second message being used to determine that the first RRC parameter group is completed. By transmitting the first message, this application helps a first node with the execution of a proper RRC parameter group, which enhances the reliability and the traffic continuity.

### CROSS REFERENCE TO RELATED APPLICATIONS

This application is the continuation of the international patent application No. PCT/CN2021/132051, filed on Nov. 22, 2021, and claims the priority benefit of Chinese Patent Application No. 202011339063.1, filed on Nov. 25, 2020, the full disclosure of which is incorporated herein by reference.

### BACKGROUND

### Technical Field

The present application relates to transmission methods and devices used in wireless communication systems, and in particular to a transmission method and device in wireless communications for reducing traffic interruption, enhancing traffic continuity and improving the reliability during employment of the relay.

### Related Art

Application scenarios of future wireless communication systems are becoming increasingly diversified, and different application scenarios have different performance demands on systems. In order to meet different performance requirements of various application scenarios, the 3rd Generation Partner Project (3GPP) Radio Access Network (RAN) #72 plenary decided to conduct the study of New Radio (NR), or what is called fifth Generation (5G). The work Item (WI) of NR was approved at the 3GPP RAN #75 plenary to standardize the NR.

In communications, both Long Term Evolution (LTE) and 5G NR involves correct reception of reliable information, optimized energy efficiency ratio (EER), determination of information validity, flexible resource allocation, elastic system structure, effective information processing on non-access stratum (NAS), and lower traffic interruption and call drop rate, and support to lower power consumption, which play an important role in the normal communication between a base station and a User Equipment (UE), rational scheduling of resources, and also in the balance of system payload, thus laying a solid foundation for increasing throughput, meeting a variety of traffic needs in communications, enhancing the spectrum utilization and improving service quality. Therefore, LTE and 5G are indispensable no matter in enhanced Mobile BroadBand (eMBB), Ultra Reliable Low Latency Communication (URLLC) or enhanced Machine Type Communication (eMTC). And a wide range of requests can be found in terms of Industrial Internet of Things (IIoT), Vehicular to X (V2X), and Device to Device (D2D), Unlicensed Spectrum communications, and monitoring on UE communication quality, network plan optimization, Non Terrestrial Network (NTN) and Terrestrial Network (TN), Dual connectivity system, or combined, radio resource management and multi-antenna codebook selection, as well as signaling design, neighbor management, traffic management and beamforming. Information is generally transmitted by broadcast and unicast, and both ways are beneficial to fulfilling the above requests and make up an integral part of the 5G system. To enlarge the coverage of the network and improve the system's reliability, information can also be forwarded via relaying.

As the number and complexity of system scenarios increases, more and more requests have been made on reducing interruption rate and latency, strengthening reliability and system stability, increasing the traffic flexibility and power conservation, and in the meantime the compatibility between different versions of systems shall be taken into account for system designing.

### SUMMARY

In multiple communication scenarios, especially in the network supporting relay, which involves reliable transmitted data and the continuity of data transmission, for instance, a low-cost IoT device or V2X device, due to their potential state of mobility, are likely to face the issue of instability in network connections, which is more severe and complex than the mobility of terminals in general mobile networks; for instance, in a scenario of transmitting via relay, the relay node itself might be moving, or might experience a handover, thus one or more cells to which it connects are likely to be changed. For some applications, particularly for those having demands on both delay and reliability, the issue of reliability shall be addressed. In the case full of unstable and unreliable connections, with the requirement for satisfying higher reliability, it will be necessary to provide further coordination to ensure more reliable transmission. In the network protocols and interfaces of NR specially designed for inter-node communications like V2X, sidelink and relevant techniques are being used and studied. In previous studies, the sidelink is used for relaying, particularly for L2 relaying, however, the studies are not very thorough or fruitful, especially when it comes to the requirements for higher reliability and continuity. In a conventional practice, when a link breaks down or fails, a terminal will have to spend some time on searching for and establishing a new link, which will cause the data interruption. This cannot be problem-solving. An ideal solution is provided in the present application to configure a group of or multiple groups of RRC parameters for a user, when a relay node goes through a handover, and the cell changes, the relay node triggers and then a remote user determines and executes suitable RRC parameters, so that a quick response can be made to such change that happens to the relay node, and will change according to specific conditions of the relay node and specific configurations of RRC parameters, thus attaining an ideal result. The method proposed by the present application ensures a relatively low delay and power consumption and smaller resource consumption, as well as an ideal communication continuity, plus a reduction in the complexity in terms of implementation, hence a good solution to the above problems.

To address the above problem, the present application provides a solution.

It should be noted that if no conflict is incurred, embodiments in any node in the present application and the characteristics of the embodiments are also applicable to any other node, and vice versa. What's more, the embodiments in the present application and the characteristics in the embodiments can be arbitrarily combined if there is no conflict.

The present application provides a method in a first node for wireless communications, comprising:

receiving a first radio signal and a second radio signal; the first radio signal comprising a first signaling, and the second radio signal comprising a first message; the first signaling being used to indicate a first RRC parameter group set, the first RRC parameter group set comprising Q Radio Resource Control (RRC) parameter groups, Q being a positive integer greater than 1, while the first message being used to determine a first RRC parameter group from the first RRC parameter group set;

executing the first RRC parameter group; and

transmitting a second message; the second message being used to determine that the first RRC parameter group is completed;

herein, the first RRC parameter group belongs to the first RRC parameter group set; the first message is transmitted via a sidelink SRB, while the first signaling is transmitted via an SRB, the SRB used for transmitting the first signaling being configured for the first cell group, the first cell group comprising at least one cell.

In one embodiment, a problem to be solved in the present application includes: how to ensure the reliability and continuity of transmissions of a remote node when a terminal is within unstable network, particularly when a handover of a relay node occurs; as the relay node moves, a target/destination cell of the relay node may be a cell within a same group, or maybe not; after the movement, a remote user needs to make a response, otherwise, it will lose its connection with the network. Since the mobility is involved in many specific scenarios, the coordination among users may be very complicated, so there arises a significant issue that whether the continuity of communications of the remote user can be ensured using a simpler and flexible method. As proposed by the present application, using pre-configured RRC parameter groups, like RRC parameter groups that apply to various conditions, and then selecting and executing based on specific conditions when the relay node is moving will be a favorable method, which can avoid the delay of re-establishing the link, reduce the power consumption and management complexity, thus addressing the above issue.

In one embodiment, an advantage of the above method includes: avoiding the introduction of complex and rigid mobility management process while guaranteeing the continuity and reliability of traffics of a remote node; a user can adaptively select RRC parameter groups for different mobility-related scenarios, which largely enhances the flexibility.

Specifically, according to one aspect of the present application, the Q RRC parameter groups respectively correspond to Q cell groups; the first message is used to indicate a second cell group, the second cell group being used to determine a target cell group, and the first RRC parameter group being an RRC parameter group corresponding to the target cell group among the Q RRC parameter groups, where the target cell group is one of the Q cell groups; a cell group comprises at least one cell.

Specifically, according to one aspect of the present application, when there is one and only cell group among the Q cell groups that comprises one cell in the second cell group, the target cell group is a cell group comprising the cell among the Q cell groups.

Specifically, according to one aspect of the present application, when there are multiple cell groups among the Q cell groups that comprise at least one cell in the second cell group, the target cell group is a cell group among the multiple cell groups.

Specifically, according to one aspect of the present application, comprising: transmitting a third message;

herein, the third message is transmitted via the sidelink SRB, the third message indicating at least one cell belonging to both the second cell group and the target cell group.

Specifically, according to one aspect of the present application, when any cell in the second cell group does not belong to the Q cell groups, the target cell group is the first cell group.

Specifically, according to one aspect of the present application, when any cell in the second cell group does not belong to the Q cell groups, comprising:

as a response to receiving the first message, releasing the sidelink SRB.

Specifically, according to one aspect of the present application, when any cell in the second cell group does not belong to the Q cell groups, the first node receives a first physical signal, the first physical signal being used for generating a first received quality, when the first received quality is greater than a first threshold, the first cell group is determined to be the target cell group.

Specifically, according to one aspect of the present application, the first message is used for indicating whether a link of the first signaling is available.

Specifically, according to one aspect of the present application, transmitting a first report, the first report being used to indicate a PDCP SDU received via a link of the first signaling

Specifically, according to one aspect of the present application, the first node is a UE.

Specifically, according to one aspect of the present application, the first node is a terminal of Internet of Things (IoT).

Specifically, according to one aspect of the present application, the first node is a relay.

Specifically, according to one aspect of the present application, the first node is a vehicle-mounted terminal.

Specifically, according to one aspect of the present application, the first node is an aircraft.

The present application provides a method in a second node for wireless communications, comprising:

transmitting a first radio signal and a second radio signal; the first radio signal comprising a first signaling, and the second radio signal comprising a first message; the first signaling being used to indicate a first RRC parameter group set, the first RRC parameter group set comprising Q Radio Resource Control (RRC) parameter groups, Q being a positive integer greater than 1, while the first message being used to determine a first RRC parameter group from the first RRC parameter group set; and

a receiver of the first signaling, executing a first RRC parameter group;

herein, the first RRC parameter group belongs to the first RRC parameter group set; the first message is transmitted via a sidelink SRB, while the first signaling is transmitted via an SRB, the SRB used for transmitting the first signaling being configured for the first cell group, the first cell group comprising at least one cell.

Specifically, according to one aspect of the present application, receiving a first signaling, the first signaling being used to generate the first radio signal.

Specifically, according to one aspect of the present application, the Q RRC parameter groups respectively correspond to Q cell groups; the first message is used to indicate a second cell group, the second cell group being used to determine a target cell group, and the first RRC parameter group being an RRC parameter group corresponding to the target cell group among the Q RRC parameter groups, where the target cell group is one of the Q cell groups; a cell group comprises at least one cell.

Specifically, according to one aspect of the present application, when there is one and only cell group among the Q cell groups that comprises one cell in the second cell group, the target cell group is a cell group comprising the cell among the Q cell groups.

Specifically, according to one aspect of the present application, when there are multiple cell groups among the Q cell groups that comprise at least one cell in the second cell group, the target cell group is a cell group among the multiple cell groups.

Specifically, according to one aspect of the present application, comprising: receiving a third message;

herein, the third message is transmitted via the sidelink SRB, the third message indicating at least one cell belonging to both the second cell group and the target cell group.

Specifically, according to one aspect of the present application, when any cell in the second cell group does not belong to the Q cell groups, the target cell group is the first cell group.

Specifically, according to one aspect of the present application, the first message is used for indicating whether a link of the first signaling is available.

Specifically, according to one aspect of the present application, receiving a fourth message, the fourth message indicating a first RLC bearer and a first radio bearer, the first RLC bearer being associated with the first radio bearer, and the first RLC bearer being an RLC bearer of a Uu interface;

the third message is used for activating the first RLC bearer.

Specifically, according to one aspect of the present application, the second receiver 1201 receives a second message; the second transmitter 1201 forwards the second message.

Specifically, according to one aspect of the present application, the first node is a UE.

Specifically, according to one aspect of the present application, the first node is a terminal of Internet of Things (IoT).

Specifically, according to one aspect of the present application, the first node is a relay.

Specifically, according to one aspect of the present application, the first node is a vehicle-mounted terminal.

Specifically, according to one aspect of the present application, the first node is an aircraft.

The present application provides a method in a third node for wireless communications, comprising:

transmitting a first signaling; the first signaling being used to indicate a first RRC parameter group set, the first RRC parameter group set comprising Q RRC parameter groups, Q being a positive integer greater than 1;

a receiver of the first signaling, executing a first RRC parameter group; and

receiving a second message; the second message being used to determine that the first RRC parameter group is completed;

herein, the first RRC parameter group belongs to the first RRC parameter group set; the first signaling is transmitted via an SRB, the SRB used for transmitting the first signaling being configured for the first cell group, the first cell group comprising at least one cell.

Specifically, according to one aspect of the present application, the Q RRC parameter groups respectively correspond to Q cell groups; the first message is used to indicate a second cell group, the second cell group being used to determine a target cell group, and the first RRC parameter group being an RRC parameter group corresponding to the target cell group among the Q RRC parameter groups, where the target cell group is one of the Q cell groups; a cell group comprises at least one cell.

Specifically, according to one aspect of the present application, when there is one and only cell group among the Q cell groups that comprises one cell in the second cell group, the target cell group is a cell group comprising the cell among the Q cell groups.

Specifically, according to one aspect of the present application, when there are multiple cell groups among the Q cell groups that comprise at least one cell in the second cell group, the target cell group is a cell group among the multiple cell groups.

Specifically, according to one aspect of the present application, when any cell in the second cell group does not belong to the Q cell groups, the target cell group is the first cell group.

Specifically, according to one aspect of the present application, transmitting a first physical signal, the first physical signal being used for generating a first received quality, when any cell in the second cell group does not belong to the Q cell groups and when the first received quality is greater than a first threshold, the first cell group is determined to be the target cell group.

Specifically, according to one aspect of the present application, receiving a first report, the first report being used to indicate a PDCP SDU received via a link of the first signaling.

Specifically, according to one aspect of the present application, transmitting a fourth message, the fourth message indicating a first RLC bearer and a first radio bearer, the first RLC bearer being associated with the first radio bearer, and the first RLC bearer being an RLC bearer of a Uu interface.

Specifically, according to one aspect of the present application, transmitting a first radio signal, the first radio signal comprising the first signaling.

Specifically, according to one aspect of the present application, the third node is a base station.

Specifically, according to one aspect of the present application, the third node is a relay.

Specifically, according to one aspect of the present application, the third node is a vehicle-mounted terminal.

Specifically, according to one aspect of the present application, the third node is an aircraft.

Specifically, according to one aspect of the present application, the third node is a group header.

Specifically, according to one aspect of the present application, the third node is a satellite.

The present application provides a first node for wireless communications, comprising:

a first receiver, receiving a first radio signal and a second radio signal; the first radio signal comprising a first signaling, and the second radio signal comprising a first message; the first signaling being used to indicate a first RRC parameter group set, the first RRC parameter group set comprising Q Radio Resource Control (RRC) parameter groups, Q being a positive integer greater than 1, while the first message being used to determine a first RRC parameter group from the first RRC parameter group set;

a first processor, executing the first RRC parameter group; and

a first transmitter, transmitting a second message; the second message being used to determine that the first RRC parameter group is completed;

herein, the first RRC parameter group belongs to the first RRC parameter group set; the first message is transmitted via a sidelink SRB, while the first signaling is transmitted via an SRB, the SRB used for transmitting the first signaling being configured for the first cell group, the first cell group comprising at least one cell.

The present application provides a second node for wireless communications, comprising:

a second transmitter, transmitting a first radio signal and a second radio signal; the first radio signal comprising a first signaling, and the second radio signal comprising a first message; the first signaling being used to indicate a first RRC parameter group set, the first RRC parameter group set comprising Q Radio Resource Control (RRC) parameter groups, Q being a positive integer greater than 1, while the first message being used to determine a first RRC parameter group from the first RRC parameter group set; and

a receiver of the first signaling, executing a first RRC parameter group;

herein, the first RRC parameter group belongs to the first RRC parameter group set; the first message is transmitted via a sidelink SRB, while the first signaling is transmitted via an SRB, the SRB used for transmitting the first signaling being configured for the first cell group, the first cell group comprising at least one cell.

The present application provides a third node for wireless communications, comprising:

a third transmitter, transmitting a first signaling; the first signaling being used to indicate a first RRC parameter group set, the first RRC parameter group set comprising Q RRC parameter groups, Q being a positive integer greater than 1;

a receiver of the first signaling, executing a first RRC parameter group; and

a third receiver, receiving a second message; the second message being used to determine that the first RRC parameter group is completed;

herein, the first RRC parameter group belongs to the first RRC parameter group set; the first signaling is transmitted via an SRB, the SRB used for transmitting the first signaling being configured for the first cell group, the first cell group comprising at least one cell.

In one embodiment, compared with the prior art, the present application is advantageous in the following aspects:

In scenarios where sidelink relay is used, due to the fact that the user is likely to be moving, the relay node is likely to be moving, and even the base station is likely to be moving, there might be multiple relay nodes as well sometimes; the user can directly connect to a serving cell, or may need to be connected to the serving cell by relay for its coverage situation, or selects a relay to connect to the serving cell out of internal algorithm; these nodes may have no fixed or constant geographic positions or relations, or may not be able to support an air interface technique of the serving cell, for instance millimeter-wave; such circumstances are commonly seen in V2X, IoT or wearables; since sidelink communications usually happen in a short distance, it is necessary to change users and even relay nodes frequently; this will lead to traffic discontinuity. For communications of L2 relay type, after the relay node moves, for instance, after the relay node's being switched to other cell(s), the context and bearer of a remote cell are still in a remote node and the original serving cell. Since the handover of the relay node causes the remote node to lose its signaling linkage with the original cell, nor is there a signaling linkage with a new cell, as a result, the remote node is disconnected from the network. A conventional method is to make a remote user re-establish or to make a fresh start to establish a connection after finding that the previous connection is failed, which requires quite a many signaling procedure that may lead to a period of communication interruption. Such consequence is bad for traffics having certain demands on the delay and is energy-consuming, when energy is of great importance to an IoT-type terminal Another possible method is to process the relay and the remote user as a whole, but this will make the handover process and mobility management very complicated, so that the previous process of mobility management cannot be simply reused, and the situation in which a target cell of the relay node supports no relay is hard to deal with. Since the remote user and the relay are both likely to move, and there are various target cells, and the coverage situations vary a lot, a single set of signaling procedures can hardly apply to all conditions, which means that this is not an ideal solution. The method provided in the present application, configures multiple groups of RRC parameters, i.e., a first RRC parameter group set, and, after the relay node moves, can immediately apply these RRC parameters, which enables the remote node to complete the process of mobility afterwards, and furthermore, the RRC parameters are provided for different scenarios, so a remote user will only need to make a proper choice of specific RRC parameters to ensure continuous traffics.

### BRIEF DESCRIPTION OF THE DRAWINGS

Other features, objects and advantages of the present application will become more apparent from the detailed description of non-restrictive embodiments taken in conjunction with the following drawings:

FIG. 1 illustrates a flowchart of receiving a first radio signal and a second radio signal, executing a first RRC parameter group and transmitting a second message according to one embodiment of the present application.

FIG. 2 illustrates a schematic diagram of a network architecture according to one embodiment of the present application.

FIG. 3 illustrates a schematic diagram of a radio protocol architecture of a user plane and a control plane according to one embodiment of the present application.

FIG. 4 illustrates a schematic diagram of a first communication device and a second communication device according to one embodiment of the present application.

FIG. 5 illustrates a flowchart of radio signal transmission according to one embodiment of the present application.

FIG. 6 illustrates a flowchart of radio signal transmission according to one embodiment of the present application.

FIG. 7 illustrates a flowchart of radio signal transmission according to one embodiment of the present application.

FIG. 8 illustrates a schematic diagram of a network structure according to one embodiment of the present application.

FIG. 9 illustrates a schematic diagram of a first message being used to determine a first RRC parameter group from a first RRC parameter group set according to one embodiment of the present application.

FIG. 10 illustrates a schematic diagram of protocol stack according to one embodiment of the present application.

FIG. 11 illustrates a structure block diagram of a processing device in a first node according to one embodiment of the present application.

FIG. 12 illustrates a structure block diagram of a processing device in a second node according to one embodiment of the present application.

FIG. 13 illustrates a structure block diagram a processing device in a third node according to one embodiment of the present application.

### DESCRIPTION OF THE EMBODIMENTS

The technical scheme of the present application is described below in further details in conjunction with the drawings. It should be noted that the embodiments of the present application and the characteristics of the embodiments may be arbitrarily combined if no conflict is caused.

### Embodiment 1

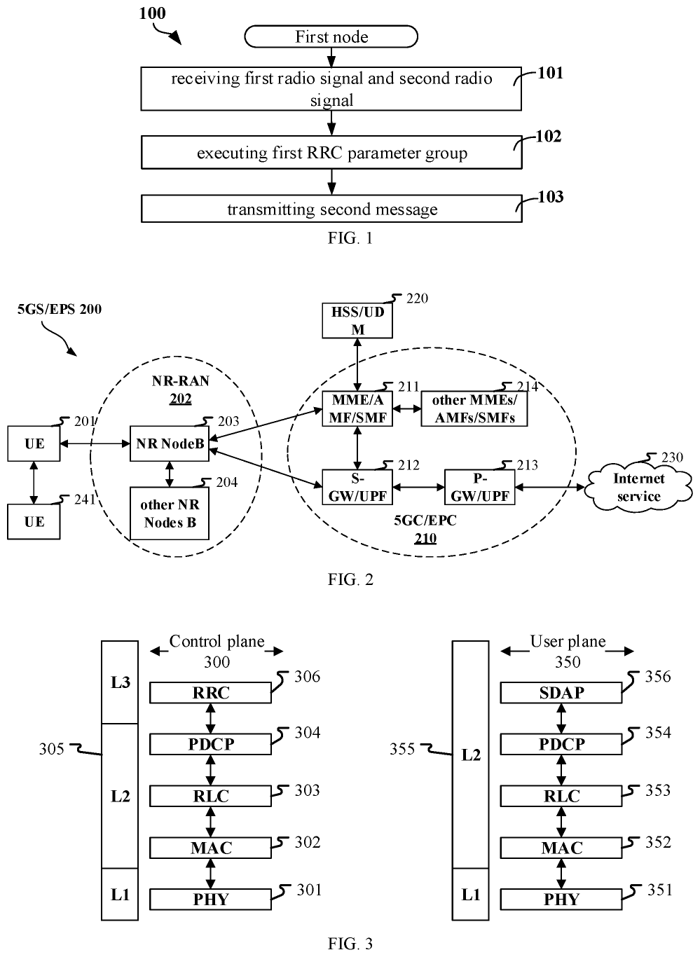

Embodiment 1 illustrates a flowchart of receiving a first radio signal and a second radio signal, executing a first RRC parameter group and transmitting a second message according to one embodiment of the present application, as shown in FIG. 1. In FIG. 1, each step represents a step, it should be particularly noted that the sequence order of each box herein does not imply a chronological order of steps marked respectively by these boxes.

In Embodiment 1, the first node in the present application receives a first radio signal and a second radio signal in step 101; executes a first RRC parameter group in step 102; and transmits a second message in step 103;

the first radio signal comprising a first signaling, and the second radio signal comprising a first message; the first signaling being used to indicate a first RRC parameter group set, the first RRC parameter group set comprising Q Radio Resource Control (RRC) parameter groups, Q being a positive integer greater than 1, while the first message being used to determine a first RRC parameter group from the first RRC parameter group set;

the second message being used to determine that the first RRC parameter group is completed;

herein, the first RRC parameter group belongs to the first RRC parameter group set; the first message is transmitted via a sidelink SRB, while the first signaling is transmitted via an SRB, the SRB used for transmitting the first signaling being configured for the first cell group, the first cell group comprising at least one cell.

In one embodiment, the first node is a remote node.

In one embodiment, the first node is a remote UE.

In one embodiment, the first radio signal and the second radio signal are respectively physical-layer signals.

In one embodiment, a transmitter of the first radio signal is identical to that of the second radio signal.

In one subembodiment, a transmitter of the first radio signal is a transmitter of the first message.

In one subembodiment, a transmitter of the first radio signal is a relay node.

In one embodiment, a transmitter of the first radio signal is different from that of the second radio signal.

In one subembodiment, a transmitter of the first radio signal is a serving cell of the first node; a transmitter of the second radio signal is a relay node of the first node.

In one embodiment, a cell group only comprises one cell, which means that a cell group is a cell.

In one embodiment, a cell group comprises more than one cell.

In one embodiment, numbers of cells comprised by different cell groups are identical.

In one embodiment, numbers of cells comprised by different cell groups are different.

In one embodiment, the first processor determines that a first condition set is satisfied.

In one embodiment, the first condition set comprises that the first message is received.

In one embodiment, as a response to the first condition set being satisfied, the first node executes a first RRC parameter group.

In one embodiment, the SRB used for transmitting the first signaling is configured for the first cell group.

In one embodiment, the sentence that “the SRB used for transmitting the first signaling is configured for the first cell group” includes the following meaning:

In one embodiment, the SRB used for transmitting the first signaling is associated with an RLC Bearer of a cell in the first cell group.

In one embodiment, the SRB used for transmitting the first signaling is associated with an RLC Bearer of multiple cells in the first cell group.

In one embodiment, the SRB used for transmitting the first signaling is controlled by a Pcell of the first cell group.

In one embodiment, the SRB used for transmitting the first signaling is controlled by a PScell of the first cell group.

In one embodiment, the SRB used for transmitting the first signaling is controlled by a master node (MN) of the first cell group.

In one embodiment, one end of the SRB used for transmitting the first signaling is a master node (MN) of the first cell group.

In one embodiment, the SRB used for transmitting the first signaling is terminated at a master node (MN) of the first cell group.

In one embodiment, the MN is for the first node.

In one embodiment, the SRB used for transmitting the first signaling is configured for a Special Primary Cell (SpCell) in the first cell group.

In one embodiment, the MN of the first cell group is for the first node.

In one embodiment, a master node (MN) of the first cell group for a relay node of the first node is identical to an MN of the first cell group for the first node.

In one embodiment, a master node (MN) of the first cell group for a relay node of the first node is different from an MN of the first cell group for the first node.

In one embodiment, a Pcell of the first cell group for a relay node of the first node is identical to a Pcell of the first cell group for the first node.

In one embodiment, a Pcell of the first cell group for a relay node of the first node is different from a Pcell of the first cell group for the first node.

In one embodiment, a SPcell of the first cell group for a relay node of the first node is identical to a SPcell of the first cell group for the first node.

In one embodiment, a PScell of the first cell group for a relay node of the first node is identical to a PScell of the first cell group for the first node.

In one embodiment, a PScell of the first cell group for a relay node of the first node is different from a PScell of the first cell group for the first node.

In one embodiment, the Q does not exceed 64.

In one embodiment, the Q does not exceed 32.

In one embodiment, the Q RRC parameter groups respectively correspond to Q cell groups, where the first RRC parameter group corresponds to a target cell group, the target cell group being one of the Q cell groups, where a cell group comprises at least one cell.

In one embodiment, each RRC parameter group among the Q RRC parameter groups comprises RRCReconfiguration.

In one embodiment, each RRC parameter group among the Q RRC parameter groups comprises RRCConnectionReconfiguration.

In one embodiment, each RRC parameter group among the Q RRC parameter groups comprises CellGroupConfig or radioBearerConfig.

In one embodiment, each RRC parameter group among the Q RRC parameter groups comprises ConditionalReconfiguration.

In one embodiment, each RRC parameter group among the Q RRC parameter groups comprises at least partial fields in ConditionalReconfiguration.

In one embodiment, each RRC parameter group among the Q RRC parameter groups comprises at least partial fields in RRCReconfiguration.

In one embodiment, each RRC parameter group among the Q RRC parameter groups comprises condReconfigId.

In one embodiment, each RRC parameter group among the Q RRC parameter groups comprises condExecutionCond.

In one embodiment, each RRC parameter group among the Q RRC parameter groups comprises condRRCReconfig.

In one embodiment, the sentence “executing a first RRC parameter group” includes the following meaning:

In one embodiment, the first node applies the first RRC parameter group;

In one embodiment, the first node executes each parameter in the first RRC parameter group;

In one embodiment, the first node at least executes one parameter in the first RRC parameter group;

In one embodiment, the first node determines to execute RRC parameter(s) in the first RRC parameter group according to a relay type, and at least executes one parameter in the first RRC parameter group;

In one embodiment, the first node determines to execute RRC parameter(s) in the first RRC parameter group according to whether a relay is used, and at least executes one parameter in the first RRC parameter group;

In one embodiment, the first node determines to execute RRC parameter(s) in the first RRC parameter group according to the first message, and at least executes one parameter in the first RRC parameter group.

In one embodiment, the first signaling comprises an RRC signaling.

In one embodiment, the first radio signal bears the first signaling.

In one embodiment, the second radio signal bears the first message.

In one embodiment, the first signaling comprises RRCReconfiguration.

In one embodiment, the first signaling comprises part of Information Elements (IEs) in RRCReconfiguration.

In one embodiment, the first message comprises an RRC signaling.

In one embodiment, the first message comprises a PC5-S signaling.

In one embodiment, the first message comprises a PC5-RRC signaling.

In one embodiment, a transmitter of the first message is a relay node.

In one embodiment, the first message comprises a discovery message.

In one embodiment, a way of transmitting the first message includes unicast or broadcast or groupcast.

In one embodiment, the first message comprises a CellIdentity.

In one embodiment, the first message comprises a physicalCellld.

In one embodiment, the first message comprises an NR Cell Global Identifier (NCGI).

In one embodiment, the first message indicates a serving cell change.

In one embodiment, the first message indicates a SpCell change.

In one embodiment, the first message indicates a PCell change.

In one embodiment, the first message indicates a PSCell change.

In one embodiment, the first message indicates a serving cell change, where the serving cell indicated by the first message is an MN of the first node.

In one embodiment, the first message indicates a serving cell change, where the serving cell indicated by the first message is a Primary Cell (PCell) of the first node.

In one embodiment, the first message indicates a serving cell change, where the serving cell indicated by the first message is a SpCell of the first node.

In one embodiment, the first message indicates a serving cell change, where the serving cell indicated by the first message is a SpCell of the first node but is not a SpCell of a transmitter of the first message.

In one embodiment, the first message indicates a serving cell change, where the serving cell indicated by the first message is a SpCell of the first node but is not a SpCell of a relay node.

In one embodiment, the first message indicates whether a link of the first signaling is available.

In one subembodiment, the first message indicates whether a link of the first signaling is available.

In one subembodiment, when the first message does not comprise any cell, the first message indicates that a link of the first signaling is unavailable; when the first message comprises at least one cell, the first message indicates that a link of the first signaling is available.

In one subembodiment, when the first message does not comprise any cell group, the first message indicates that a link of the first signaling is unavailable; when the first message comprises at least one cell group, the first message indicates that a link of the first signaling is available.

In one subembodiment, when the first message does not comprise any cell group, the first message indicates that a link of the first signaling is unavailable; when the first message comprises the second cell group, the first message indicates that a link of the first signaling is available.

In one embodiment, the sentence that “whether a link of the first signaling is available” includes the following meaning:

In one embodiment, a radio link used for transmitting the first signaling is a link of the first signaling;

In one embodiment, a link of the first signaling is an RRC connection of the first node;

In one embodiment, a link of the first signaling is the SRB of the first node used for transmitting the first signaling;

In one embodiment, a link of the first signaling is an RLC bearer of the SRB of the first node used for transmitting the first signaling;

In one embodiment, a link of the first signaling is a link relayed by a relay node;

In one embodiment, a link of the first signaling is a link relayed by a transmitter of the first message;

In one embodiment, a link of the first signaling is a connection relayed by a transmitter of the first message;

In one embodiment, a link of the first signaling is a bearer relayed by a transmitter of the first message;

In one embodiment, a link of the first signaling is a radio bearer relayed by a transmitter of the first message;

In one embodiment, a link of the first signaling is a part of a radio bearer relayed by a transmitter of the first message;

In one embodiment, a link of the first signaling is an RLC bearer of a radio bearer relayed by a transmitter of the first message.

In one embodiment, the SRB used for transmitting the first signaling includes an SRB1.

In one embodiment, the SRB used for transmitting the first signaling includes an SRB2.

In one embodiment, the SRB used for transmitting the first signaling includes an SRB3.

In one embodiment, the SRB used for transmitting the first signaling includes an SRB0.

In one embodiment, the sidelink SRB includes a sidelink SRB.

In one embodiment, the sidelink SRB includes a sidelink SRB1.

In one embodiment, the sidelink SRB includes a sidelink SRB2.

In one embodiment, the sidelink SRB includes a sidelink SRB3.

In one embodiment, the SRB refers to Signaling Radio Bearer.

In one embodiment, the SRB is a signaling radio bearer.

In one embodiment, the sidelink SRB is an SRB of a PC5 interface.

In one embodiment, the sidelink SRB is associated with an RLC bearer of a PC5 interface.

In one embodiment, the SRB used for transmitting the first signaling is an SRB of a Uu interface.

In one embodiment, the SRB used for transmitting the first signaling is associated with an RLC bearer of a Uu interface.

In one embodiment, the SRB used for transmitting the first signaling is simultaneously associated with an RLC bearer of a Uu interface and an RLC bearer of a PC5 interface.

In one embodiment, one end of the SRB used for transmitting the first signaling is terminated at the first node, while the other end is terminated at a serving cell of the first node.

In one embodiment, one end of the sidelink SRB is terminated at the first node, while the other end is terminated at a relay node of the first node.

In one embodiment, the first signaling is transmitted by a Uu interface.

In one embodiment, the second message is an RRC message.

In one embodiment, the second message is transmitted by the SRB used for transmitting the first signaling.

In one embodiment, the second message is transmitted by an SRB1.

In one embodiment, the second message is transmitted by an SRB2.

In one embodiment, the second message is transmitted by an SRB3.

In one embodiment, the second message comprises RRCReconfigurationComplete.

In one embodiment, the second message comprises at least partial fields in RRCReconfigurationComplete.

In one embodiment, the second message comprises RRCConnectionReconfigurationComplete.

In one embodiment, the second message comprises at least partial fields in RRCConnectionReconfigurationComplete.

In one embodiment, the second message comprises RRCSetupComplete.

In one embodiment, the second message comprises RRCResumeComplete.

In one embodiment, the second message comprises RRCReestablishmentComplete.

In one embodiment, the second message explicitly indicates that the first RRC parameter group is completed.

In one embodiment, the sentence that “the first RRC parameter group is completed” includes the following meaning:

In one embodiment, the first RRC parameter group is executed till completion;

In one embodiment, the first RRC parameter group is applied till completion;

In one embodiment, at least part of parameters in the first RRC parameter group are executed till completion;

In one embodiment, at least part of parameters in the first RRC parameter group are applied till completion.

In one embodiment, the second message is used for feedback of the first signaling.

In one embodiment, the SRB used for transmitting the first signaling is an MCG bearer.

In one embodiment, the SRB used for transmitting the first signaling is an SCG bearer.

In one embodiment, the second message comprises a random access signal;

in one subembodiment, the random access signal is a contention-free random access signal.

In one embodiment, the second message comprises a MAC CE.

In one embodiment, the second message comprises an msgA.

In one embodiment, the first cell group is one of the Q cell groups.

In one subembodiment, an RRC parameter group corresponding to the first cell group among the Q RRC parameter groups comprises a configuration parameter of the SRB used for transmitting the first signaling.

In one embodiment, any cell in the Q cell groups other than the first cell group is not a serving cell of the first node when receiving the first signaling.

In one embodiment, there exists no cell that belongs to 2 cell groups among the Q cell groups simultaneously.

### Embodiment 2

Embodiment 2 illustrates a schematic diagram of a network architecture according to the present application, as shown in FIG. 2.

FIG. 2 is a diagram illustrating a network architecture 200 of 5G NR, Long-Term Evolution (LTE) and Long-Term Evolution Advanced (LTE-A) systems. The 5G NR or LTE network architecture 200 may be called 5G System/Evolved Packet System (5GS/EPS) 200 or other appropriate terms. The 5GS/EPS 200 may comprise one or more UEs 201, an NG-RAN 202, a 5G-Core Network/Evolved Packet Core (5GC/EPC) 210, a Home Subscriber Server/Unified Data Management (HSS/UDM) 220 and an Internet Service 230. The 5GS/EPS 200 may be interconnected with other access networks. For simple description, the entities/interfaces are not shown. As shown in FIG. 2, the 5GS/EPS 200 provides packet switching services. Those skilled in the art will find it easy to understand that various concepts presented throughout the present application can be extended to networks providing circuit switching services or other cellular networks. The NG-RAN 202 comprises an NR node B (gNB) 203 and other gNBs 204. The gNB 203 provides UE 201-oriented user plane and control plane terminations. The gNB 203 may be connected to other gNBs 204 via an Xn interface (for example, backhaul). The gNB 203 may be called a base station, a base transceiver station, a radio base station, a radio transceiver, a transceiver function, a Base Service Set (BSS), an Extended Service Set (ESS), a Transmitter Receiver Point (TRP) or some other applicable terms. The gNB 203 provides an access point of the 5GC/EPC 210 for the UE 201. Examples of UE 201 include cellular phones, smart phones, Session Initiation Protocol (SIP) phones, laptop computers, Personal Digital Assistant (PDA), Satellite Radios, non-terrestrial base station communications, satellite mobile communications, Global Positioning Systems (GPSs), multimedia devices, video devices, digital audio players (for example, MP3 players), cameras, games consoles, unmanned aerial vehicles, air vehicles, narrow-band physical network equipment, machine-type communication equipment, land vehicles, automobiles, wearable equipment, or any other devices having similar functions. Those skilled in the art also can call the UE 201 a mobile station, a subscriber station, a mobile unit, a subscriber unit, a wireless unit, a remote unit, a mobile device, a wireless device, a radio communication device, a remote device, a mobile subscriber station, an access terminal, a mobile terminal, a wireless terminal, a remote terminal, a handset, a user proxy, a mobile client, a client or some other appropriate terms. The gNB 203 is connected with the 5G-CN/EPC 210 via an Sl/NG interface. The 5G-CN/EPC 210 comprises a Mobility Management Entity (MME)/Authentication Management Field (AMF)/Session Management Function (SMF) 211, other MMES/AMFs/SMFs 214, a Service Gateway (S-GW)/User Plane Function (UPF) 212 and a Packet Date Network Gateway (P-GW)/UPF 213. The MME/AMF/SMF 211 is a control node for processing a signaling between the UE 201 and the 5GC/EPC 210. Generally, the MME/AMF/SMF 211 provides bearer and connection management. All user Internet Protocol (IP) packets are transmitted through the S-GW/UPF 212. The S-GW/UPF 212 is connected to the P-GW/UPF 213. The P-GW 213 provides UE IP address allocation and other functions. The P-GW/UPF 213 is connected to the Internet Service 230. The Internet Service 230 comprises IP services corresponding to operators, specifically including Internet, Intranet, IP Multimedia Subsystem (IMS) and Packet Switching Streaming (PSS) services.

In one embodiment, the UE 201 corresponds to the first node in the present application.

In one embodiment, the UE 201 corresponds to the second node in the present application.

In one embodiment, the UE 201 supports transmissions in NTN.

In one embodiment, the UE 201 supports transmissions in large-delay-difference networks.

In one embodiment, the UE 201 supports V2X transmission.

In one embodiment, the UE 201 supports relay transmission.

In one embodiment, the UE 241 corresponds to the first node in the present application.

In one embodiment, the UE 241 corresponds to the second node in the present application.

In one embodiment, the UE 241 supports transmissions in NTN.

In one embodiment, the UE 241 supports transmissions in large-delay-difference networks.

In one embodiment, the UE 241 supports V2X transmission.

In one embodiment, the UE 241 supports relay transmission.

In one embodiment, the UE 201 and the UE241 transmit to each other using a sidelink.

In one embodiment, the gNB203 corresponds to the third node in the present application.

In one embodiment, the gNB203 supports transmissions in NTN.

In one embodiment, the gNB203 supports transmissions in large-delay-difference networks.

In one embodiment, the gNB203 supports V2X transmission.

In one embodiment, the gNB203 supports MBS transmission.

In one embodiment, the gNB203 supports MBMS transmission.

In one embodiment, the gNB203 supports relay transmission.

In one embodiment, the gNB203 supports sidelink transmission.

### Embodiment 3

Embodiment 3 illustrates a schematic diagram of a radio protocol architecture of a user plane and a control plane according to the present application, as shown in FIG. 3. FIG. 3 is a schematic diagram illustrating an embodiment of a radio protocol architecture of a user plane 350 and a control plane 300. In FIG. 3, the radio protocol architecture for a control plane 300 between a first node (UE, gNB or, satellite or aircraft in NTN) and a second node (gNB, UE, or satellite or aircraft in NTN), or between two UEs, is represented by three layers, which are a layer 1, a layer 2 and a layer 3, respectively. The layer 1 (L1) is the lowest layer which performs signal processing functions of various PHY layers. The L1 is called PHY 301 in the present application. The layer 2 (L2) 305 is above the PHY 301, and is in charge of the link between a first node and a second node as well as between two UEs via the PHY 301. The L2 305 comprises a Medium Access Control (MAC) sublayer 302, a Radio Link Control (RLC) sublayer 303 and a Packet Data Convergence Protocol (PDCP) sublayer 304. All these sublayers terminate at the second nodes. The PDCP sublayer 304 provides multiplexing among variable radio bearers and logical channels. The PDCP sublayer 304 provides security by encrypting packets and also support for inter-cell handover of the first node between nodes. The RLC sublayer 303 provides segmentation and reassembling of a higher-layer packet, retransmission of a lost packet, and reordering of a packet so as to compensate the disordered receiving caused by Hybrid Automatic Repeat reQuest (HARQ). The MAC sublayer 302 provides multiplexing between a logical channel and a transport channel. The MAC sublayer 302 is also responsible for allocating between first nodes various radio resources (i.e., resource block) in a cell. The MAC sublayer 302 is also in charge of HARQ operation. In the control plane 300, The RRC sublayer 306 in the L3 layer is responsible for acquiring radio resources (i.e., radio bearer) and configuring the lower layer using an RRC signaling between the second node and the first node. The radio protocol architecture in the user plane 350 comprises the L1 layer and the L2 layer. In the user plane 350, the radio protocol architecture used for the first node and the second node in a PHY layer 351, a PDCP sublayer 354 of the L2 layer 355, an RLC sublayer 353 of the L2 layer 355 and a MAC sublayer 352 of the L2 layer 355 is almost the same as the radio protocol architecture used for corresponding layers and sublayers in the control plane 300, but the PDCP sublayer 354 also provides header compression used for higher-layer packet to reduce radio transmission overhead. The L2 layer 355 in the user plane 350 also comprises a Service Data Adaptation Protocol (SDAP) sublayer 356, which is in charge of the mapping between QoS streams and a Data Radio Bearer (DRB), so as to support diversified traffics. Although not described in FIG. 3, the first node may comprise several higher layers above the L2 355. Besides, the first node comprises a network layer (i.e., IP layer) terminated at a P-GW 213 of the network side and an application layer terminated at the other side of the connection (i.e., a peer UE, a server, etc.).

In one embodiment, the radio protocol architecture in FIG. 3 is applicable to the first node in the present application.

In one embodiment, the radio protocol architecture in FIG. 3 is applicable to the second node in the present application.

In one embodiment, the radio protocol architecture in FIG. 3 is applicable to the third node in the present application.

In one embodiment, the first radio signal in the present application is generated by the PHY301 or the PHY351.

In one embodiment, the second radio signal in the present application is generated by the PHY301 or the PHY351.

In one embodiment, the first physical-layer signal in the present application is generated by the PHY301 or the PHY351.

In one embodiment, the first signaling in the present application is generated by the RRC 306.

In one embodiment, the first message in the present application is generated by the PHY301, or the PHY351, or the MAC302, or the MAC352, or the RLC303, or the RLC353, or the RRC306 or the NAS.

In one embodiment, the first report in the present application is generated by the RLC303 or the RLC353 or the PDCP304 or the PDCP354.

In one embodiment, the second message in the present application is generated by the PHY301, or the PHY351, or the MAC302, or the MAC352, or the RRC306.

In one embodiment, the third message in the present application is generated by the MAC302 or the MAC352, or the RRC306.

In one embodiment, the fourth message in the present application is generated by the RRC306.

### Embodiment 4

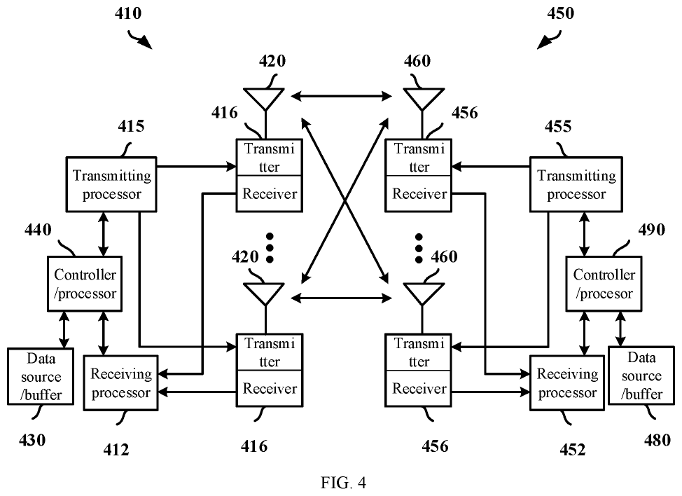

Embodiment 4 illustrates a schematic diagram of a first communication device and a second communication device according to the present application, as shown in FIG. 4. FIG. 4 is a block diagram of a first communication device 450 and a second communication device 410 in communication with each other in an access network.

The first communication device 450 comprises a controller/processor 459, a memory 460, a data source 467, a transmitting processor 468, a receiving processor 456, a multi-antenna transmitting processor 457, a multi-antenna receiving processor 458, a transmitter/receiver 454 and an antenna 452.

The second communication device 410 comprises a controller/processor 475, a memory 476, a receiving processor 470, a transmitting processor 416, a multi-antenna receiving processor 472, a multi-antenna transmitting processor 471, a transmitter/receiver 418 and an antenna 420.

In a transmission from the second communication device 410 to the first communication device 450, at the second communication device 410, a higher layer packet from a core network is provided to the controller/processor 475. The controller/processor 475 provides functions of the L2 layer. In the transmission from the second communication device 410 to the first communication device 450, the controller/processor 475 provides header compression, encryption, packet segmentation and reordering, and multiplexing between a logical channel and a transport channel, and radio resource allocation of the first communication device 450 based on various priorities. The controller/processor 475 is also in charge of HARQ operation, a retransmission of a lost packet and a signaling to the first communication device 450. The transmitting processor 416 and the multi-antenna transmitting processor 471 perform various signal processing functions used for the L1 layer (i.e., PHY). The transmitting processor 416 performs coding and interleaving so as to ensure a Forward Error Correction (FEC) at the second communication device 410 side and the mapping to signal clusters corresponding to each modulation scheme (i.e., BPSK, QPSK, M-PSK, and M-QAM, etc.). The multi-antenna transmitting processor 471 performs digital spatial precoding, which includes precoding based on codebook and precoding based on non-codebook, and beamforming processing on encoded and modulated signals to generate one or more spatial streams. The transmitting processor 416 then maps each spatial stream into a subcarrier. The mapped symbols are multiplexed with a reference signal (i.e., pilot frequency) in time domain and/or frequency domain, and then they are assembled through Inverse Fast Fourier Transform (IFFT) to generate a physical channel carrying time-domain multicarrier symbol streams. After that the multi-antenna transmitting processor 471 performs transmission analog precoding/beamforming on the time-domain multicarrier symbol streams. Each transmitter 418 converts a baseband multicarrier symbol stream provided by the multi-antenna transmitting processor 471 into a radio frequency (RF) stream, which is later provided to different antennas 420.

In a transmission from the second communication device 410 to the first communication device 450, at the first communication device 450, each receiver 454 receives a signal via a corresponding antenna 452. Each receiver 454 recovers information modulated to the RF carrier, and converts the radio frequency stream into a baseband multicarrier symbol stream to be provided to the receiving processor 456. The receiving processor 456 and the multi-antenna receiving processor 458 perform signal processing functions of the L1 layer. The multi-antenna receiving processor 458 performs reception analog precoding/beamforming on a baseband multicarrier symbol stream provided by the receiver 454. The receiving processor 456 converts baseband multicarrier symbol streams which have gone through reception analog precoding/beamforming operations from time domain to frequency domain using FFT. In frequency domain, physical layer data signals and reference signals are de-multiplexed by the receiving processor 456, where the reference signals are used for channel estimation while data signals are processed in the multi-antenna receiving processor 458 by multi-antenna detection to recover any spatial stream targeting the first communication device 450. Symbols on each spatial stream are demodulated and recovered in the receiving processor 456 to generate a soft decision. Then the receiving processor 456 decodes and de-interleaves the soft decision to recover the higher-layer data and control signal transmitted by the second communication device 410 on the physical channel. Next, the higher-layer data and control signal are provided to the controller/processor 459. The controller/processor 459 provides functions of the L2 layer. The controller/processor 459 can be associated with a memory 460 that stores program code and data. The memory 460 can be called a computer readable medium. In the transmission from the second communication device 410 to the second communication device 450, the controller/processor 459 provides demultiplexing between a transport channel and a logical channel, packet reassembling, decrypting, header decompression and control signal processing so as to recover a higher-layer packet from the core network. The higher-layer packet is later provided to all protocol layers above the L2 layer. Or various control signals can be provided to the L3 for processing.

In a transmission from the first communication device 450 to the second communication device 410, at the first communication device 450, the data source 467 is configured to provide a higher-layer packet to the controller/processor 459. The data source 467 represents all protocol layers above the L2 layer. Similar to a transmitting function of the second communication device 410 described in the transmission from the second communication node 410 to the first communication node 450, the controller/processor 459 performs header compression, encryption, packet segmentation and reordering, and multiplexing between a logical channel and a transport channel based on radio resource allocation so as to provide the L2 layer functions used for the user plane and the control plane. The controller/processor 459 is also responsible for a retransmission of a lost packet, and a signaling to the second communication device 410. The transmitting processor 468 performs modulation and mapping, as well as channel coding, and the multi-antenna transmitting processor 457 performs digital multi-antenna spatial precoding, including precoding based on codebook and precoding based on non-codebook, and beamforming. The transmitting processor 468 then modulates generated spatial streams into multicarrier/single-carrier symbol streams. The modulated symbol streams, after being subjected to analog precoding/beamforming in the multi-antenna transmitting processor 457, are provided from the transmitter 454 to each antenna 452. Each transmitter 454 first converts a baseband symbol stream provided by the multi-antenna transmitting processor 457 into a radio frequency symbol stream, and then provides the radio frequency symbol stream to the antenna 452.

In a transmission from the first communication device 450 to the second communication device 410, the function of the second communication device 410 is similar to the receiving function of the first communication device 450 described in the transmission from the second communication device 410 to the first communication device 450. Each receiver 418 receives a radio frequency signal via a corresponding antenna 420, converts the received radio frequency signal into a baseband signal, and provides the baseband signal to the multi-antenna receiving processor 472 and the receiving processor 470. The receiving processor 470 and the multi-antenna receiving processor 472 jointly provide functions of the L1 layer. The controller/processor 475 provides functions of the L2 layer. The controller/processor 475 can be associated with the memory 476 that stores program code and data. The memory 476 can be called a computer readable medium. In the transmission from the first communication device 450 to the second communication device 410, the controller/processor 475 provides de-multiplexing between a transport channel and a logical channel, packet reassembling, decrypting, header decompression, control signal processing so as to recover a higher-layer packet from the first communication device (UE) 450. The higher-layer packet coming from the controller/processor 475 may be provided to the core network.

In one embodiment, the first communication device 450 comprises at least one processor and at least one memory, the at least one memory comprises computer program codes; the at least one memory and the computer program codes are configured to be used in collaboration with the at least one processor. The first communication device 450 at least: receives a first radio signal and a second radio signal; the first radio signal comprising a first signaling, and the second radio signal comprising a first message; the first signaling being used to indicate a first RRC parameter group set, the first RRC parameter group set comprising Q Radio Resource Control (RRC) parameter groups, Q being a positive integer greater than 1, while the first message being used to determine a first RRC parameter group from the first RRC parameter group set; executes the first RRC parameter group; and transmits a second message; the second message being used to determine that the first RRC parameter group is completed; herein, the first RRC parameter group belongs to the first RRC parameter group set; the first message is transmitted via a sidelink SRB, while the first signaling is transmitted via an SRB, the SRB used for transmitting the first signaling being configured for the first cell group, the first cell group comprising at least one cell.

In one embodiment, the first communication node 450 comprises a memory that stores a computer readable instruction program, the computer readable instruction program generates actions when executed by at least one processor, which include: receiving a first radio signal and a second radio signal; the first radio signal comprising a first signaling, and the second radio signal comprising a first message; the first signaling being used to indicate a first RRC parameter group set, the first RRC parameter group set comprising Q Radio Resource Control (RRC) parameter groups, Q being a positive integer greater than 1, while the first message being used to determine a first RRC parameter group from the first RRC parameter group set; executing the first RRC parameter group; and transmitting a second message; the second message being used to determine that the first RRC parameter group is completed; herein, the first RRC parameter group belongs to the first RRC parameter group set; the first message is transmitted via a sidelink SRB, while the first signaling is transmitted via an SRB, the SRB used for transmitting the first signaling being configured for the first cell group, the first cell group comprising at least one cell.

In one embodiment, the first communication device 450 comprises at least one processor and at least one memory, the at least one memory comprises computer program codes; the at least one memory and the computer program codes are configured to be used in collaboration with the at least one processor. The first communication device 450 at least: transmits a first radio signal and a second radio signal; the first radio signal comprising a first signaling, and the second radio signal comprising a first message; the first signaling being used to indicate a first RRC parameter group set, the first RRC parameter group set comprising Q Radio Resource Control (RRC) parameter groups, Q being a positive integer greater than 1, while the first message being used to determine a first RRC parameter group from the first RRC parameter group set; a receiver of the first signaling, executing a first RRC parameter group; and herein, the first RRC parameter group belongs to the first RRC parameter group set; the first message is transmitted via a sidelink SRB, while the first signaling is transmitted via an SRB, the SRB used for transmitting the first signaling being configured for the first cell group, the first cell group comprising at least one cell.

In one embodiment, the first communication node 450 comprises a memory that stores a computer readable instruction program, the computer readable instruction program generates actions when executed by at least one processor, which include: transmitting a first radio signal and a second radio signal; the first radio signal comprising a first signaling, and the second radio signal comprising a first message; the first signaling being used to indicate a first RRC parameter group set, the first RRC parameter group set comprising Q Radio Resource Control (RRC) parameter groups, Q being a positive integer greater than 1, while the first message being used to determine a first RRC parameter group from the first RRC parameter group set; a receiver of the first signaling, executing a first RRC parameter group; and herein, the first RRC parameter group belongs to the first RRC parameter group set; the first message is transmitted via a sidelink SRB, while the first signaling is transmitted via an SRB, the SRB used for transmitting the first signaling being configured for the first cell group, the first cell group comprising at least one cell.

In one embodiment, the second communication device 410 comprises at least one processor and at least one memory, the at least one memory comprises computer program codes; the at least one memory and the computer program codes are configured to be used in collaboration with the at least one processor. The second communication device 410 at least: transmits a first signaling; the first signaling being used to indicate a first RRC parameter group set, the first RRC parameter group set comprising Q RRC parameter groups, Q being a positive integer greater than 1; a receiver of the first signaling, executing a first RRC parameter group; and receives a second message; the second message being used to determine that the first RRC parameter group is completed; herein, the first RRC parameter group belongs to the first RRC parameter group set; the first signaling is transmitted via an SRB, the SRB used for transmitting the first signaling being configured for the first cell group, the first cell group comprising at least one cell.

In one embodiment, the second communication device 410 comprises a memory that stores a computer readable instruction program, the computer readable instruction program generates actions when executed by at least one processor, which include: transmitting a first signaling; the first signaling being used to indicate a first RRC parameter group set, the first RRC parameter group set comprising Q RRC parameter groups, Q being a positive integer greater than 1; a receiver of the first signaling, executing a first RRC parameter group; and receiving a second message; the second message being used to determine that the first RRC parameter group is completed; herein, the first RRC parameter group belongs to the first RRC parameter group set; the first signaling is transmitted via an SRB, the SRB used for transmitting the first signaling being configured for the first cell group, the first cell group comprising at least one cell.

In one embodiment, the first communication device 450 corresponds to the first node in the present application.

In one embodiment, the second communication device 410 corresponds to a second node in the present application.

In one embodiment, the second communication device 410 corresponds to the third node in the present application.

In one embodiment, the first communication device 450 is a UE.

In one embodiment, the first communication device 450 is a vehicle-mounted terminal.

In one embodiment, the first communication device 450 is a relay.

In one embodiment, the second communication device 410 is a base station.

In one embodiment, the second communication device 410 is a relay.

In one embodiment, the second communication device 410 is a UE.

In one embodiment, the second communication device 410 is a satellite.

In one embodiment, the receiver 456 (comprising the antenna 460), the receiving processor 452 and the controller/processor 490 are used for receiving the first radio signal in the present application.

In one embodiment, the receiver 456 (comprising the antenna 460), the receiving processor 452 and the controller/processor 490 are used for receiving the second radio signal in the present application.

In one embodiment, the receiver 456 (comprising the antenna 460), the receiving processor 452 and the controller/processor 490 are used for receiving the first physical-layer signal in the present application.

In one embodiment, the receiver 456 (comprising the antenna 460), the receiving processor 452 and the controller/processor 490 are used for receiving the first signaling in the present application.

In one embodiment, the receiver 456 (comprising the antenna 460), the receiving processor 452 and the controller/processor 490 are used for receiving the first message in the present application.

In one embodiment, the transmitter 456 (comprising the antenna 460), the transmitting processor 455 and the controller/processor 490 are used for transmitting the second message in the present application.

In one embodiment, the transmitter 456 (comprising the antenna 460), the transmitting processor 455 and the controller/processor 490 are used for transmitting the third message in the present application.

In one embodiment, the transmitter 456 (comprising the antenna 460), the transmitting processor 455 and the controller/processor 490 are used for transmitting the first report in the present application.

In one embodiment, the transmitter 456 (comprising the antenna 460), the transmitting processor 455 and the controller/processor 490 are used for transmitting the first radio signal in the present application.

In one embodiment, the transmitter 456 (comprising the antenna 460), the transmitting processor 455 and the controller/processor 490 are used for transmitting the second radio signal in the present application.

In one embodiment, the transmitter 456 (comprising the antenna 460), the transmitting processor 455 and the controller/processor 490 are used for transmitting the first message in the present application.

In one embodiment, the receiver 456 (comprising the antenna 460), the receiving processor 452 and the controller/processor 490 are used for receiving the third message in the present application.

In one embodiment, the receiver 456 (comprising the antenna 460), the receiving processor 452 and the controller/processor 490 are used for receiving the fourth message in the present application.

In one embodiment, the transmitter 416 (comprising the antenna 420), the transmitting processor 412 and the controller/processor 440 are used for transmitting the first signaling in the present application.

In one embodiment, the transmitter 416 (comprising the antenna 420), the transmitting processor 412 and the controller/processor 440 are used for transmitting the first physical-layer signal in the present application.

In one embodiment, the transmitter 416 (comprising the antenna 420), the transmitting processor 412 and the controller/processor 440 are used for transmitting the fourth message in the present application.

In one embodiment, the receiver 416 (comprising the antenna 420), the receiving processor 412 and the controller/processor 440 are used for receiving the first report in the present application.

### Embodiment 5

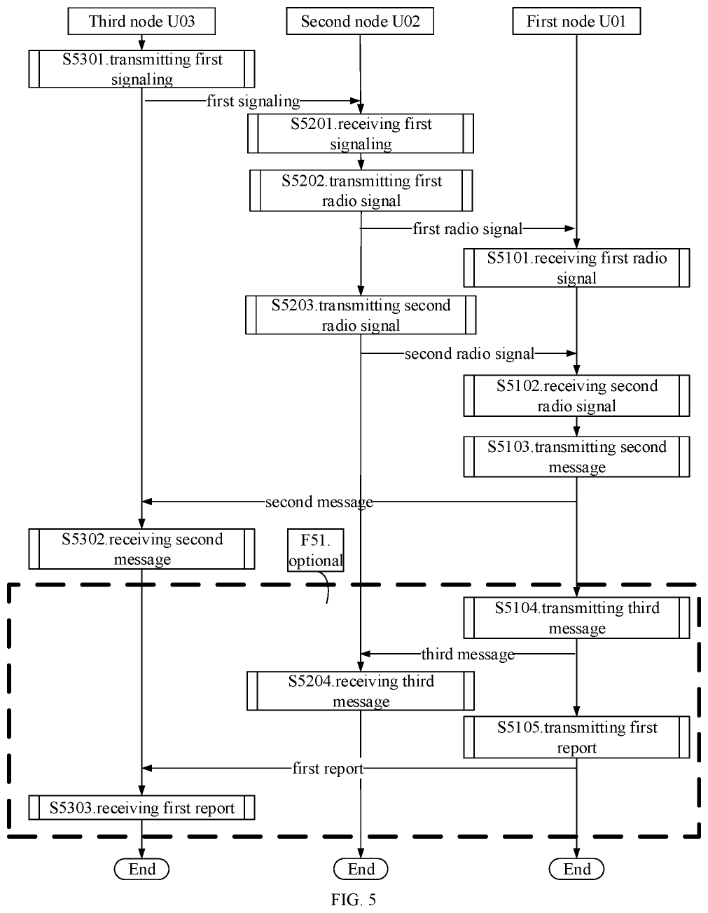

Embodiment 5 illustrates a flowchart of radio signal transmission according to one embodiment of the present application, as shown in FIG. 5. In FIG. 5, U01 corresponds to a first node in the present application, U02 corresponds to a second node in the present application, and a third node U03 corresponds to a third node in the present application. It should be particularly noted that the order presented in this embodiment does not limit the order of signal transmissions or the order of implementations of the present application; herein, steps marked by the F51 are optional.

The first node U01 receives a first radio signal in step S5101; and receives a second radio signal in step S5102; transmits a second message in step S5103; transmits a third message in step S5104; and transmits a first report in step S5105.

The second node U02 receives a first signaling in step S5201; transmits the first radio signal in step S5202; transmits the second radio signal in step S5203; and receives the third message in step S5204.

The third node U03 transmits the first signaling in step S5301; receives the second message in step S5302; and receives the first report in step S5303.

In Embodiment 5, the first radio signal comprises a first signaling, and the second radio signal comprises a first message; the first signaling being used to indicate a first RRC parameter group set, the first RRC parameter group set comprising Q Radio Resource Control (RRC) parameter groups, Q being a positive integer greater than 1, while the first message being used to determine a first RRC parameter group from the first RRC parameter group set; the first node U01 executes the first RRC parameter group; the second message being used to determine that the first RRC parameter group is completed; the first RRC parameter group belongs to the first RRC parameter group set; the first message is transmitted via a sidelink SRB, while the first signaling is transmitted via an SRB, the SRB used for transmitting the first signaling being configured for the first cell group, the first cell group comprising at least one cell.

In one embodiment, the first node U01 is a UE.

In one embodiment, the first node U01 is a remote UE.

In one embodiment, the second node U02 is a relay node.

In one embodiment, the second node U02 is a L2 relay node.

In one embodiment, the second node U02 is a UE.

In one embodiment, the second node U02 is an IAB node.

In one embodiment, the second node U02 is a relay of the first node U01.

In one embodiment, the third node U03 is a PCell of the first node U01.

In one embodiment, the third node U03 is a PSCell of the first node U01.

In one embodiment, the third node U03 is a SpCell of the first node U01.

In one embodiment, the third node U03 is an MCG of the first node U01.

In one embodiment, the third node U03 is a target cell of the first node U01.

In one embodiment, the third node U03 is a relay of the first node U01.

In one embodiment, the third node U03 is a L3 relay or IAB node of the first node U01.

In one embodiment, the third node U03 is the first cell group.

In one embodiment, the third node U03 is a serving cell of the first cell group.

In one embodiment, the third node U03 is a serving cell of the second node U02.

In one embodiment, the third node U03 is a SpCell of the second node U02.

In one embodiment, the third node U03 is a PCell of the second node U02.

In one embodiment, the third node U03 is a PSCell of the second node U02.

In one embodiment, the third node U03 is a cell other than a SpCell of the second node U02.

In one embodiment, the third node U03 is an SCell of the second node U02.

In one embodiment, the third node U03 is an SCell of the second node U02; the third node U03 is a SPCell of the first node U01.

In one embodiment, the third node U03 and the second node U02 are in communication via a Uu interface.

In one embodiment, the first node U01 and the second node U02 are in communication via a PC5 interface.

In one embodiment, the SRB used for transmitting the first signaling is an SRB between the third node U03 and the first node U01.

In one embodiment, the sidelink SRB is an SRB between the second node U02 and the first node U01.

In one embodiment, the first signaling is an RRC signaling.

In one embodiment, the first signaling is used for generating the first radio signal.

In one embodiment, the first radio signal bears or carries the first signaling.

In one embodiment, the second node U02 forwards the first signaling via the first radio signal.

In one embodiment, the first radio signal is transmitted via the PC5 interface.

In one embodiment, the second radio signal is transmitted via the PC5 interface.

In one embodiment, the second node U02 generates the first message, the first message being a PC5-RRC or PC5-S message.

In one embodiment, the Q RRC parameter groups respectively correspond to Q cell groups; the first message is used to indicate a second cell group, the second cell group being used to determine a target cell group, and the first RRC parameter group being an RRC parameter group corresponding to the target cell group among the Q RRC parameter groups, where the target cell group is one of the Q cell groups; a cell group comprises at least one cell.

In one embodiment, the second cell group only comprises one cell.

In one embodiment, the second cell group comprises more than one cell.

In one embodiment, the second cell group is a target cell of the second node U02.

In one embodiment, the second cell group is a target cell group of the second node U02.

In one embodiment, the second cell group is an MCG of the second node U02.

In one embodiment, the second cell group is an SCG of the second node U02.

In one embodiment, the second cell group comprises a target cell of the second node U02.

In one embodiment, the second cell group comprises a SpCell of the second node U02.

In one embodiment, the second cell group comprises a PCell of the second node U02.

In one embodiment, when the first message is transmitted, the second cell group comprises a PCell of the second node U02.

In one embodiment, before the first message is transmitted, a change occurs in a SpCell of the second node U02.

In one embodiment, before the first message is transmitted, a handover occurs in the second node U02.

In one embodiment, the second cell group is at least one of an MCG or an SCG of the second node U02, the second cell group not comprising the first cell group.

In one embodiment, the second cell group is at least one of an MCG or an SCG of the second node U02, the second cell group being different from the first cell group.

In one embodiment, the second cell group is at least one of an MCG or an SCG of the second node U02, the second cell group not comprising a PCell of the first node U01.

In one embodiment, the second cell group is at least one of an MCG or an SCG of the second node U02, the second cell group not comprising a SpCell of the first node U01.

In one embodiment, each RRC parameter group among the Q RRC parameter groups comprises a corresponding cell group.

In one embodiment, each RRC parameter group among the Q RRC parameter groups comprises a corresponding cell group, where the corresponding cell group comprised by each RRC parameter group is a SpCell.

In one subembodiment, each RRC parameter group configures through spCellConfig that each RRC parameter group comprises the cell group corresponding to the RRC parameter group.

In one embodiment, the target cell group comprises a serving cell of the first node U01.

In one embodiment, the target cell group comprises a serving cell in RRC connection with the first node U01.

In one embodiment, when there is one and only cell group among the Q cell groups that comprises one cell in the second cell group, the target cell group is a cell group comprising the cell among the Q cell groups.

In one subembodiment, the second cell group only comprises one cell, the second cell group being a SpCell of the second node U02, each cell group among the Q cell groups respectively comprises only one cell, where the second cell group is determined to be an MCG of the first node U01.

In one subembodiment, the second cell group only comprises one cell, the second cell group being a SpCell of the second node U02, each cell group among the Q cell groups respectively comprises only one cell, where a cell comprised by the second cell group is determined to be a SpCell of the first node U01.

In one subembodiment, the second cell group only comprises one cell, the second cell group being a SpCell of the second node U02, each cell group among the Q cell groups respectively comprises only one cell, where a cell comprised in the second cell group is determined to be a Pcell of the first node U01.

In one subembodiment, the first node U01 selects a SpCell of the second node U02 as a SpCell of the first node U01.

In one subembodiment, the second cell group only comprises the cell.

In one embodiment, when there is and only an i-th cell group among the Q cell groups that comprises cells in the second cell group, the i-th cell group is determined to be the target cell group.

In one subembodiment, the i-th cell group is an identifier of a cell group among the Q cell groups, which is unrelated to the specific value of i.

In one embodiment, when there is and only a j1-th cell group among the Q cell groups that comprises a cell j2 in the second cell group, and the cell j2 is configured as a SpCell or PCell of the first node U01, the j1-th cell group is determined to be the target cell group.

In one subembodiment, the j1-th cell group is an identifier of a cell group among the Q cell groups, which is unrelated to the specific value of j1.

In one subembodiment, j2 is used for identifying a cell, which is unrelated to the specific value of j2.

In one embodiment, when there are multiple cell groups among the Q cell groups that comprise at least one cell in the second cell group, the target cell group is a cell group among the multiple cell groups.

In one embodiment, the first node U01 itself determines the target cell group out of the multiple cell groups.

In one embodiment, the target cell group is a cell group having a smallest cell group identity among the multiple cell groups.

In one embodiment, the cell group identity is a CellGroupId.

In one embodiment, the cell group identity is 0 or 1.

In one embodiment, when there are multiple cell groups among the Q cell groups that comprise at least one cell in the second cell group, a cell group G1 is a cell group comprising at least one cell in the second cell group among the Q cell groups, where a cell that belongs to both the cell group G1 and the second cell group is configured to be a SpCell or PCell of the first node U01; the cell group G1 is determined as the target cell group.

In one subembodiment, the cell group G1 is determined to be an MCG of the first node U01.

In one subembodiment, the first RRC parameter group configures a SpCell or PCell of the first node U01, the first RRC parameter group comprising the cell group G1.

In one embodiment, when any cell in the second cell group does not belong to the Q cell groups, the target cell group is the first cell group.

In one embodiment, when any cell in the second cell group does not belong to the Q cell groups, the first cell group is determined to be the target cell group.

In one embodiment, when any cell in the second cell group is not configured to be a SpCell of the first node U01, the first cell group is determined to be the target cell group.

In one embodiment, when any cell in the second cell group is not configured to be a PCell of the first node U01, the first cell group is determined to be the target cell group.

In one embodiment, when a SpCell of the first node U01 configured by any one of the Q RRC parameter groups does not belong to the second cell group, the first cell group is determined to be the target cell group.

In one embodiment, the first node U01 transmits the second message directly to the third node U03.

In one embodiment, the first node U01 transmits the second message to the third node U03 via forwarding of the second node U02.

In one embodiment, the first message is used for indicating whether a link of the first signaling is available.

In one subembodiment, the first message explicitly indicates whether a link of the first signaling is available.

In one subembodiment, a link of the first signaling includes a link for forwarding or relaying by the second node U02.

In one subembodiment, a link of the first signaling includes a link for relaying by the second node U02 between the first node U01 and the third node U03.

In one subembodiment, a link of the first signaling includes a radio link between the second node U02 and the third node U03.

In one subembodiment, a link of the first signaling includes service relayed by the second node U02 between the first node U01 and the third node U03.

In one subembodiment, a link of the first signaling includes an RRC link of the first node U01.

In one subembodiment, a link of the first signaling includes an SRB for transmitting the first signaling.

In one subembodiment, a link of the first signaling includes a radio bearer for a Uu interface of the first node U01.

In one subembodiment, the first message indicates that a link of the first signaling is unavailable.

In one subembodiment, the first message indicates that a link of the first signaling becomes invalid.

In one subembodiment, the first message indicates that a link of the first signaling is failed.

In one subembodiment, the first message indicates that a link of the first signaling is stopped from serving.

In one subembodiment, when the first message indicates that a link of the first signaling is unavailable, the first node U01 starts a first timer, when the first timer is expired, the link of the first signaling is determined as unavailable.

In one subembodiment, the first message indicates the first timer.

In one embodiment, when any cell in the second cell group does not belong to the Q cell groups, the first node U01 releases the sidelink SRB as a response to receiving the first message.

In one embodiment, when any cell in the second cell group does not support relay services, the first node U01 releases the sidelink SRB as a response to receiving the first message.

In one embodiment, the third message is transmitted via the sidelink SRB, the third message indicating at least one cell belonging to both the second cell group and the target cell group.

In one embodiment, the third message comprises a PC5-RRC message.

In one embodiment, the third message comprises a PC5-S message.

In one embodiment, the third message indicates a SpCell in the target cell group that is determined to be the first node U01.

In one embodiment, the third message indicates a PCell in the target cell group that is determined to be the first node U01.

In one embodiment, the third message indicates the target cell group.

In one embodiment, the third message indicates that the first node U01 determines a cell in the second cell group to be a SpCell or PCell of the first node U01.

In one embodiment, the third message indicates that the first node U01 determines a PCell of the second node U01 to be a PCell of the first node U01.

In one embodiment, the third message indicates that the first node U01 determines a PCell of the second node U01 to be a PCell of the first node U01, with the first RRC parameter group being applied.

In one embodiment, the third message indicates that the first node U01 determines a SpCell of the second node U01 to be a SpCell of the first node U01.

In one embodiment, the third message indicates that the first node U01 determines a PCell of the second node U01 to be a SpCell of the first node U01, with the first RRC parameter group being applied.

In one embodiment, the first node U01 transmits the first report directly to the third node U03.

In one embodiment, the first node U01 transmits the first report to the third node U03 via relaying of the second node U02.

In one embodiment, the first report is used to indicate a PDCP SDU received via a link of the first signaling.

In one subembodiment, the first report is a PDCP Satus Report.

In one subembodiment, the first report is an RLC Satus Report.

In one embodiment, reception of the first message triggers transmission of the first report.

In one embodiment, mobility of the second node U02 triggers transmission of the first report.

In one embodiment, as a response to the first node U01 determining the target cell group, the first report is transmitted.

In one embodiment, as a response to the first node U01 completing the first RRC parameter group, the first report is transmitted.

In one embodiment, as a response to the second message being transmitted, the first node U01 transmits the first report.

In one embodiment, the second cell group comprises at least two cells respectively belonging to an MCG and an SCG of the transmitter of the second radio signal.

### Embodiment 6

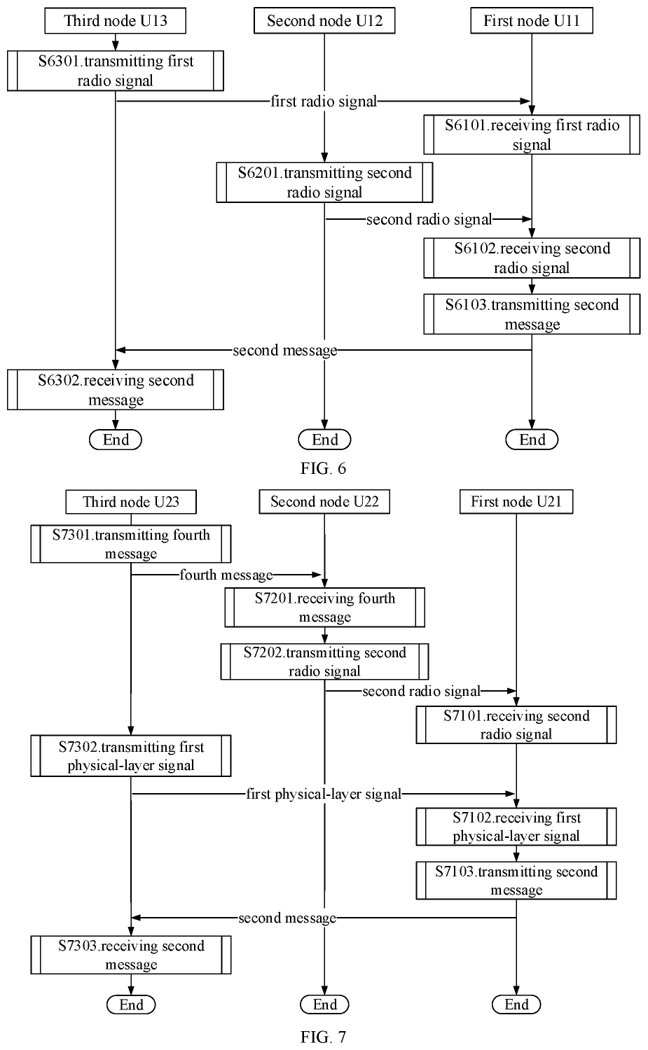

Embodiment 6 illustrates a flowchart of radio signal transmission according to one embodiment of the present application, as shown in FIG. 6. In FIG. 6, U11 corresponds to a first node in the present application, U12 corresponds to a second node in the present application, and a third node U13 corresponds to a third node in the present application. It should be particularly noted that the order presented in this embodiment does not limit the order of signal transmissions or the order of implementations of the present application. With the Embodiment 5 as the foundation of Embodiment 6, the steps required in Embodiment 6 but are not illustrated in details can refer to either Embodiment 5.

The first node U11 receives a first radio signal in step S6101; and receives a second radio signal in step S6102; and transmits a second message in step S6103.

The second node U12 transmits the second radio signal in step S6201.

The third node U13 transmits the first radio signal in step S6301; and receives the second message in step S6302.

In Embodiment 6, the first radio signal comprises a first signaling, and the second radio signal comprises a first message; the first signaling being used to indicate a first RRC parameter group set, the first RRC parameter group set comprising Q Radio Resource Control (RRC) parameter groups, Q being a positive integer greater than 1, while the first message being used to determine a first RRC parameter group from the first RRC parameter group set; the first node U11 executes the first RRC parameter group; the second message being used to determine that the first RRC parameter group is completed; the first RRC parameter group belongs to the first RRC parameter group set; the first message is transmitted via a sidelink SRB, while the first signaling is transmitted via an SRB, the SRB used for transmitting the first signaling being configured for the first cell group, the first cell group comprising at least one cell.

In one embodiment, the first node U11 is a UE.

In one embodiment, the first node U11 is a remote UE.

In one embodiment, the second node U12 is a relay node.

In one embodiment, the second node U12 is a L2 relay node.

In one embodiment, the second node U12 is a UE.

In one embodiment, the second node U12 is an IAB node.

In one embodiment, the second node U12 is a relay of the first node U11.

In one embodiment, the third node U13 is a PCell of the first node U11.

In one embodiment, the third node U13 is a PSCell of the first node U11.

In one embodiment, the third node U13 is a SpCell of the first node U11.

In one embodiment, the third node U13 is an MCG of the first node U11.

In one embodiment, the third node U13 is a target cell of the first node U11.

In one embodiment, the third node U13 is a relay of the first node U11.

In one embodiment, the third node U13 is a L3 relay or IAB node of the first node U11.

In one embodiment, the third node U13 is the first cell group.

In one embodiment, the third node U13 is a serving cell of the first cell group.

In one embodiment, the third node U13 is a serving cell of the second node U12.

In one embodiment, the third node U13 is a SpCell of the second node U12.

In one embodiment, the third node U13 is a PCell of the second node U12.

In one embodiment, the third node U13 is a PSCell of the second node U12.

In one embodiment, the third node U13 is a cell other than a SpCell of the second node U12.

In one embodiment, the third node U13 is an SCell of the second node U12.

In one embodiment, the third node U13 is an SCell of the second node U12; the third node U13 is a SPCell of the first node U11.

In one embodiment, the third node U13 and the second node U12 are in communication via a Uu interface.

In one embodiment, the first node U11 and the second node U12 are in communication via a PC5 interface.

In one embodiment, the first radio signal is transmitted to the first node U11 directly by the third node U13.

In one embodiment, the first radio signal is transmitted to the first node U11 directly by the third node U13, without using the relay node U12.

In one embodiment, the first radio signal is transmitted to the first node U11 directly by the third node U13 via a Uu interface.

In one embodiment, the first node U11 maintains at least partial RRC parameter groups in the first RRC parameter group set after establishing a relay link or using relaying service.

In one embodiment, a physical channel occupied by the first radio signal includes a PDSCH.

In one embodiment, a physical channel occupied by the first radio signal includes a PDCCH.

In one embodiment, the first radio signal is a physical layer signal of a Uu interface.

In one embodiment, the second radio signal is a physical layer signal of a PC5 interface.

In one embodiment, a physical channel occupied by the second radio signal includes a PSSCH.

In one embodiment, a physical channel occupied by the second radio signal includes a PSCCH.

In one embodiment, the sidelink SRB is a radio bearer between the first node U11 and the second node U12.

In one embodiment, the SRB used for transmitting the first signaling is a radio bearer between the first node U11 and the third node U13.

In one embodiment, the Q RRC parameter groups respectively correspond to Q cell groups; the first message is used to indicate a second cell group, the second cell group being used to determine a target cell group, and the first RRC parameter group being an RRC parameter group corresponding to the target cell group among the Q RRC parameter groups, where the target cell group is one of the Q cell groups; a cell group comprises at least one cell.

In one embodiment, when any cell in the second cell group does not support relay services, the first node U11 releases the sidelink SRB as a response to receiving the first message.

In one subembodiment, the first message indicates that any cell in the second cell group does not support relay services.

In one embodiment, when any cell in the second cell group does not belong to the Q cell groups, the first node U11 receives a first physical signal, the first physical signal being used for generating a first received quality, when the first received quality is greater than a first threshold, the first cell group is determined to be the target cell group.

In one subembodiment, the third node U13 transmits the first physical layer signal.

In one subembodiment, the first physical layer signal comprises an SSB.

In one subembodiment, the first physical layer signal comprises an SS/PBCH.

In one subembodiment, the first physical layer signal comprises a CSI-RS.

In one subembodiment, the first received quality comprises an RSRP.

In one subembodiment, the first received quality comprises an RSRQ.

In one subembodiment, the first received quality comprises an SNR.

In one subembodiment, the first received quality comprises an RSRP of the first physical layer signal.

In one subembodiment, the first received quality comprises an RSRQ of the first physical layer signal.

In one subembodiment, the first received quality comprises an SNR of the first physical layer signal.

In one subembodiment, the first threshold is indicated by the third node U13.

In one embodiment, the second cell group comprises at least two cells respectively belonging to an MCG and an SCG of the transmitter of the second radio signal.

### Embodiment 7

Embodiment 7 illustrates a flowchart of radio signal transmission according to one embodiment of the present application, as shown in FIG. 7. In FIG. 7, U21 corresponds to a first node in the present application, U22 corresponds to a second node in the present application, and a third node U23 corresponds to a third node in the present application. It should be particularly noted that the order presented in this embodiment does not limit the order of signal transmissions or the order of implementations of the present application. With the Embodiment 5 and Embodiment 6 as the foundation of Embodiment 7, the steps required in Embodiment 7 but are not illustrated in details can refer to either Embodiment 5 or Embodiment 6.

The first node U21 receives a second radio signal in step S7101, receives a first physical-layer signal in step S7102, and transmits a second message in step S7103.

The second node U22 receives a fourth message in step S7201, and transmits a second radio signal in step S7202.

The third node U23 transmits the fourth message in step S7301; transmits the first physical-layer signal in step S7302, and receives the second message in step S7303.

In Embodiment 7, the first node U21 receives a first radio signal; the first radio signal comprising a first signaling, and the second radio signal comprising a first message; the first signaling being used to indicate a first RRC parameter group set, the first RRC parameter group set comprising Q Radio Resource Control (RRC) parameter groups, Q being a positive integer greater than 1, while the first message being used to determine a first RRC parameter group from the first RRC parameter group set; the first node U21 executes the first RRC parameter group; the second message being used to determine that the first RRC parameter group is completed; the first RRC parameter group belongs to the first RRC parameter group set; the first message is transmitted via a sidelink SRB, while the first signaling is transmitted via an SRB, the SRB used for transmitting the first signaling being configured for the first cell group, the first cell group comprising at least one cell.

In one embodiment, the first node U21 is a UE.

In one embodiment, the first node U21 is a remote UE.

In one embodiment, the second node U22 is a relay node.

In one embodiment, the second node U22 is a L2 relay node.

In one embodiment, the second node U22 is a UE.

In one embodiment, the second node U22 is an IAB node.

In one embodiment, the second node U22 is a relay of the first node U21.

In one embodiment, the third node U23 is a PCell of the first node U21.

In one embodiment, the third node U23 is a PSCell of the first node U21.

In one embodiment, the third node U23 is a SpCell of the first node U21.

In one embodiment, the third node U23 is an MCG of the first node U21.

In one embodiment, the third node U23 is a target cell of the first node U21.

In one embodiment, the third node U23 is a relay of the first node U21.

In one embodiment, the third node U23 is a L3 relay or IAB node of the first node U21.

In one embodiment, the third node U23 is the first cell group.

In one embodiment, the third node U23 is a serving cell of the first cell group.

In one embodiment, the third node U23 is a serving cell of the second node U22.

In one embodiment, the third node U23 is a SpCell of the second node U22.

In one embodiment, the third node U23 is a PCell of the second node U22.

In one embodiment, the third node U23 is a PSCell of the second node U22.

In one embodiment, the third node U23 is a cell other than a SpCell of the second node U22.

In one embodiment, the third node U23 is an SCell of the second node U22.

In one embodiment, the third node U23 is an SCell of the second node U22; the third node U23 is a SPCell of the first node U21.

In one embodiment, the third node U23 and the second node U22 are in communication via a Uu interface.

In one embodiment, the first node U21 and the second node U22 are in communication via a PC5 interface.

In one embodiment, the fourth message indicates a first RLC bearer and a first radio bearer, the first RLC bearer being associated with the first radio bearer, and the first RLC bearer being an RLC bearer of a Uu interface; the third message is used for activating the first RLC bearer.

In one subembodiment, the first RLC bearer is an RLC bearer between the second node U22 and the third node U23.

In one subembodiment, the first RLC bearer is a radio bearer between the first node U21 and the third node U23.

In one subembodiment, the first radio bearer is the SRB used for transmitting the first signaling.

In one subembodiment, the first radio bearer is used for transmitting higher-layer data of the first node U21 to a serving cell.

In one subembodiment, the first radio bearer includes DRB.

In one subembodiment, the first radio bearer includes SRB.

In one subembodiment, the fourth message is used to indicate that the first node U21 uses relay service provided by the second node U22.

In one subembodiment, upon reception of the third message, the second node U02 establishes or re-establishes an entity of the first RLC bearer.

In one subembodiment, upon reception of the third message, the second node U02 starts an entity of the first RLC bearer.

In one subembodiment, upon reception of the third message, the second node U02 associates the first RLC bearer with an adaptation layer.

In one embodiment, the Q RRC parameter groups respectively correspond to Q cell groups; the first message is used to indicate a second cell group, the second cell group being used to determine a target cell group, and the first RRC parameter group being an RRC parameter group corresponding to the target cell group among the Q RRC parameter groups, where the target cell group is one of the Q cell groups; a cell group comprises at least one cell.

In one embodiment, when any cell in the second cell group does not support relay services, the first node U21 releases the sidelink SRB as a response to receiving the first message.

In one subembodiment, the first message indicates that any cell in the second cell group does not support relay services.

In one embodiment, the first message is used for indicating whether a link of the first signaling is available.

In one subembodiment, a link of the first signaling includes a link forwarded or relayed by the second node U22.

In one subembodiment, a link of the first signaling includes a radio link between the second node U22 and the third node U23.

In one subembodiment, a link of the first signaling includes a link relayed by the second node U22 between the first node U21 and the third node U23.

In one subembodiment, a link of the first signaling includes service relayed by the second node U22 between the first node U21 and the third node U23.

In one subembodiment, a link of the first signaling includes an RRC link of the first node U21.

In one subembodiment, a link of the first signaling includes an SRB for transmitting the first signaling.

In one subembodiment, a link of the first signaling includes a radio bearer for a Uu interface of the first node U21.

In one subembodiment, the first message indicates that a link of the first signaling is unavailable.

In one subembodiment, the first message indicates that a link of the first signaling becomes invalid.

In one subembodiment, the first message indicates that a link of the first signaling is failed.

In one subembodiment, the first message indicates that a link of the first signaling is stopped from serving.

In one subembodiment, when the first message indicates that a link of the first signaling is unavailable, the first node U21 starts a first timer, when the first timer is expired, the link of the first signaling is determined as unavailable.

In one subembodiment, the first message indicates the first timer.

In one embodiment, when any cell in the second cell group does not belong to the Q cell groups, the first node U21 releases the sidelink SRB as a response to receiving the first message.

In one embodiment, when any cell in the second cell group does not belong to the Q cell groups or when the first message indicates that a link of the first signaling is unavailable, the first node U21 receives a first physical signal, the first physical signal being used for generating a first received quality, when the first received quality is greater than a first threshold, the first cell group is determined to be the target cell group.

In one subembodiment, the third node U13 transmits the first physical layer signal.

In one subembodiment, the first physical layer signal comprises an SSB.

In one subembodiment, the first physical layer signal comprises an SS/PBCH.

In one subembodiment, the first physical layer signal comprises a CSI-RS.

In one subembodiment, the first received quality comprises an RSRP.

In one subembodiment, the first received quality comprises an RSRQ.

In one subembodiment, the first received quality comprises an SNR.

In one subembodiment, the first threshold is indicated by the third node U13.

In one embodiment, the first RRC parameter group comprises a parameter for establishing a second RLC bearer; the second RLC bearer is an RLC bearer between the first node U21 and the third node U23.

In one subembodiment, the second RLC Bearer is an RLC bearer of a Uu interface.

In one subembodiment, the first RRC parameter group indicates that the first radio bearer is associated with the second RLC bearer.

In one subembodiment, the first RRC parameter group indicates that the first radio bearer is no longer associated with the second RLC bearer.

### Embodiment 8

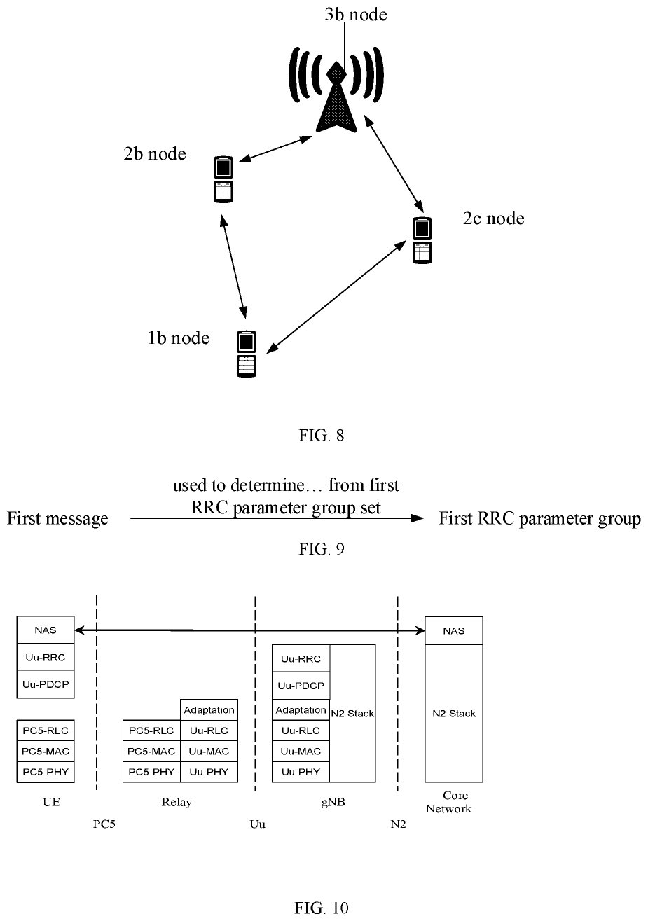

Embodiment 8 illustrates a schematic diagram of a network structure according to one embodiment of the present application, as shown in FIG. 8.

In Embodiment 8, the solid line with an arrowhead indicates the potential existence of a communication link between nodes. A 3b node corresponds to the third node in the present application, a 1b node corresponds to the first node in the present application, and a 2b node is a relay node; a 2c node corresponds to the second node in the present application.

In Embodiment 8, the 1b node receives a first radio signal and a second radio signal; the first radio signal comprising a first signaling, and the second radio signal comprising a first message; the first signaling being used to indicate a first RRC parameter group set, the first RRC parameter group set comprising Q Radio Resource Control (RRC) parameter groups, Q being a positive integer greater than 1, while the first message being used to determine a first RRC parameter group from the first RRC parameter group set; the 1b node executes the first RRC parameter group; the 1b node transmits a second message; the second message being used to determine that the first RRC parameter group is completed; herein, the first RRC parameter group belongs to the first RRC parameter group set; the first message is transmitted via a sidelink SRB, while the first signaling is transmitted via an SRB, the SRB used for transmitting the first signaling being configured for the first cell group, the first cell group comprising at least one cell.

In one embodiment, the 2c node is a relay node for the 1b node; the 3b node is a serving cell for the 1b node.

In one subembodiment, the 3b node is a primary serving cell for the 1b node.

In one embodiment, a first radio bearer is canceled at the 1b node and the 3b node.

In one embodiment, the first radio bearer is a radio bearer between the 1b node and the 3b node.

In one subembodiment, the first radio bearer is the SRB used for transmitting the first signaling.

In one subembodiment, the first radio bearer is used for transmitting higher-layer data of the first node U21 to a serving cell.

In one subembodiment, the first radio bearer includes DRB.

In one subembodiment, the first radio bearer includes SRB.

In one embodiment, a generator for the first signaling is the 3b node.

In one embodiment, the 2c node forwards the first signaling.

In one embodiment, the 2c node broadcasts discovery information.

In one embodiment, the 2c node transmits the first message.

In one embodiment, the 3b node is a source cell of the 2c node, where a cell in a second cell group is a target cell of the 2c node.

In one embodiment, the 2c node broadcasts information of its PCell periodically.

In one embodiment, the 2c node broadcasts information of the second cell group periodically.

In one embodiment, the 2c node is a group header or cluster header of the 1b node.

In one embodiment, the 2b node is a group header or cluster header of the 1b node.

In one embodiment, a first RLC bearer is an RLC bearer between the 2c node and the 3b node; the first radio bearer being associated with the first RLC bearer.

In one embodiment, the first message is used for indicating that a link of the first signaling is unavailable.

In one subembodiment, a link of the first signaling includes a link forwarded or relayed by the 2c node.

In one subembodiment, a link of the first signaling includes a radio link between the 2c node and the 3b node.

In one subembodiment, a link of the first signaling includes a link relayed by the 2c node between the 1b node and the 3b node.

In one subembodiment, a link of the first signaling includes service relayed by the 2c node between the 1b node and the 3b node.

In one subembodiment, a link of the first signaling includes an RRC link of the 1b node.

In one subembodiment, a link of the first signaling includes an SRB for transmitting the first signaling.

In one subembodiment, a link of the first signaling includes a radio bearer for a Uu interface of the 1b node.

In one subembodiment, the first message indicates that a link of the first signaling is inavailable.

In one subembodiment, the first message indicates that a link of the first signaling is not available.

In one subembodiment, the first message indicates that a link of the first signaling becomes invalid.

In one subembodiment, the first message indicates that a link of the first signaling is failed.

In one subembodiment, the first message indicates that a link of the first signaling is stopped from serving.

In one subembodiment, when the first message indicates that a link of the first signaling is unavailable, the 1b node starts a first timer, when the first timer is expired, the link of the first signaling is determined as unavailable.

In one subembodiment, the first message indicates the first timer.

In one embodiment, the 1b node receives a third physical-layer signal, the third physical-layer signal is used to determine a third received quality, the third received quality satisfying a third threshold being used to determine the first RRC parameter group.

In one subembodiment, the first RRC parameter group is a cell other than a cell indicated by the message.

In one subembodiment, the first RRC parameter group is a cell group other than a cell group indicated by the message.

In one subembodiment, a serving cell of the 1b node configures the third threshold.

In one subembodiment, internal algorithm of the 1b node configures the third threshold.

In one subembodiment, the 1b node receives the third physical-layer signal via a PC5 interface.

In one subembodiment, the third physical-layer signal can be used to determine the 2b node.

In one subembodiment, a transmitter of the third physical-layer signal is the 2b node.

In one subembodiment, the first received quality comprises an RSRP.

In one subembodiment, the first received quality comprises an RSRQ.

In one subembodiment, the first received quality comprises an SNR.

In one subembodiment, the first received quality comprises an RSRP of the first physical layer signal.

In one subembodiment, the first received quality comprises an RSRQ of the first physical layer signal.

In one subembodiment, the first received quality comprises an SNR of the first physical layer signal.

In one subembodiment, the first RRC parameter group indicates that the first radio bearer is associated with a third RLC bearer, the third RLC bearer being an RLC bearer between the 1b node and the 2b node.

In one subembodiment, the first RRC parameter group indicates that the first radio bearer is relayed by the 2b node.

### Embodiment 9

Embodiment 9 illustrates a schematic diagram of a first message being used to determine a first RRC parameter group from a first RRC parameter group set according to one embodiment of the present application, as shown in FIG. 9.

In one embodiment, the Q RRC parameter groups respectively correspond to Q cell groups; the first message is used to indicate a second cell group, the second cell group being used to determine a target cell group, and the first RRC parameter group being an RRC parameter group corresponding to the target cell group among the Q RRC parameter groups, where the target cell group is one of the Q cell groups; a cell group comprises at least one cell.

In one embodiment, the first message is used to determine the target cell group, the target cell group belonging to the Q cell groups, where the first RRC parameter group is an RRC parameter group corresponding to the target cell group.

In one embodiment, the second cell group indicated by the first message is used to determine the target cell group.

In one embodiment, when there is one and only cell group among the Q cell groups that comprises one cell in the second cell group, the target cell group is a cell group comprising the cell among the Q cell groups.

In one embodiment, when there are multiple cell groups among the Q cell groups that comprise at least one cell in the second cell group, the target cell group is a cell group among the multiple cell groups.

In one embodiment, the first message indicates that a link of the first signaling is unavailable, when the link of the first signaling is unavailable, the cell is determined to be the target cell group, where the first RRC parameter group is an RRC parameter group corresponding to the target cell group.

In one embodiment, when any cell in the second cell group does not belong to the Q cell groups, the target cell group is the first cell group; the first RRC parameter group is an RRC parameter group corresponding to the target cell group.

### Embodiment 10

Embodiment 10 illustrates a schematic diagram of protocol stack according to one embodiment of the present application, as shown in FIG. 10. With Embodiment 3 as the foundation, Embodiment 10 illustrates a control-plane protocol stack and interface related to the relay node.

In Embodiment 10, NAS is a Non-access Stratum, Uu-RRC is an RRC protocol for the Uu interface, Uu-PDCP is a PDCP entity of the Uu interface, Uu-RLC is an RLC entity of a Uu interface, Uu-MAC is a MAC entity of the Uu interface, and Uu-PHY is a physical-layer entity of the Uu interface; PC5-RLC is an RLC entity of a PC5 interface, PC5-MAC is a MAC entity of the PC5 interface, and PC5-PHY is a physical-layer entity of the PC5 interface; Adaptation is an adaptation entity between a relay node and the network; N2 Stack is a protocol stack of an N2 interface; and N2 interface is an interface between a gNB and the core network.

In one embodiment, the Q RRC parameter groups respectively correspond to Q cell groups; the first message is used to indicate a second cell group, the second cell group being used to determine a target cell group, and the first RRC parameter group being an RRC parameter group corresponding to the target cell group among the Q RRC parameter groups, where the target cell group is one of the Q cell groups; a cell group comprises at least one cell.

In one embodiment, as shown in FIG. 10, a UE corresponds to the first node in the present application, a relay corresponds to the second node in the present application, and a gNB corresponds to the third node in the present application.

In one subembodiment, the first radio bearer is a radio bearer between a UE and the gNB.

In one subembodiment, the first RLC bearer is an RLC bearer of a Uu interface, the first RLC bearer being an RLC bearer between the relay and the gNB.

In one subembodiment, the sidelink SRB is an SRB between the UE and the relay.

In one subembodiment, the SRB used for transmitting the first signaling is an SRB between the UE and the gNB.

In one subembodiment, there exists one cell that simultaneously belong to the target cell group, the second cell group and the gNB.

In one subembodiment, a cell group among the Q cell groups that comprises at least one cell belonging to a same gNB as cells comprised in the second cell group is determined to be the target cell group.

In one subembodiment, a generator for the first signaling is the gNB.

In one subembodiment, a generator for the first message is the relay.

In one subembodiment, a transmitter of the first radio signal and the second radio signal is the relay.

In one subembodiment, a transmitter of the first radio signal is the gNB; a transmitter of the second radio signal is the relay.

In one subembodiment, reception of the first message is used for triggering that the UE determines the target cell group.

In one subembodiment, the target cell group only comprises one cell.

In one subembodiment, the target cell group is a cell.

In one subembodiment, determination of the target cell group is used to trigger that the UE executes the first RRC parameter group.

In one subembodiment, the first RRC parameter group comprises at least one cell in the target cell group.

In one subembodiment, the first RRC parameter group comprises the target cell group.

In one subembodiment, the second message is transmitted using the SRB used for transmitting the first signaling.

In one subembodiment, a receiver of the second message is the same as a generator for the first signaling.

In one subembodiment, a receiver of the second message is different from a generator for the first signaling.

In one subembodiment, a receiver of the second message is a node capable of decoding the second message.

In one subembodiment, the second message is used for acknowledging that the UE is in communication with the gNB in a direct way.

In one subembodiment, the second message is used for acknowledging that the UE is in communication with the gNB in a relayed way.

### Embodiment 11

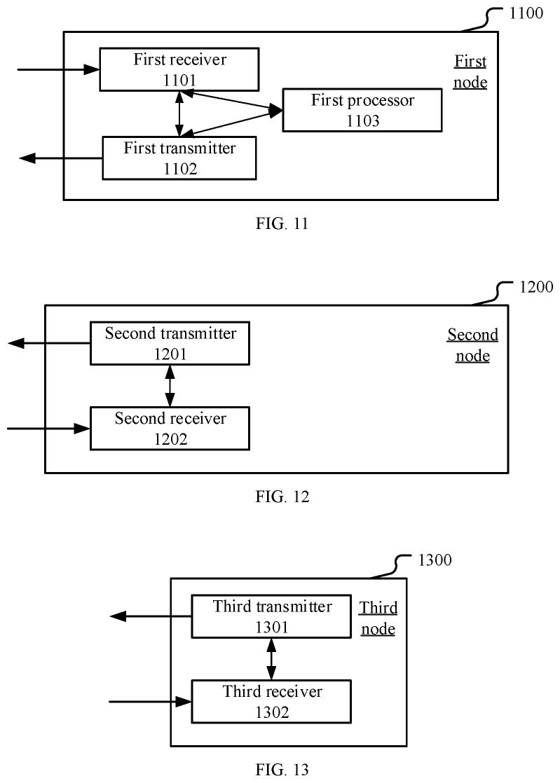

Embodiment 11 illustrates a structure block diagram of a processing device used in a first node according to one embodiment of the present application; as shown in FIG. 11. In FIG. 11, a processing device 1100 in the first node comprises a first receiver 1101, a first transmitter 1102 and a first processor 1103. In Embodiment 11, the first receiver 1101 receives a first radio signal and a second radio signal; the first radio signal comprising a first signaling, and the second radio signal comprising a first message; the first signaling being used to indicate a first RRC parameter group set, the first RRC parameter group set comprising Q Radio Resource Control (RRC) parameter groups, Q being a positive integer greater than 1, while the first message being used to determine a first RRC parameter group from the first RRC parameter group set;

the first processor 1103 executes the first RRC parameter group; and

the first transmitter 1102 transmits a second message; the second message being used to determine that the first RRC parameter group is completed;

herein, the first RRC parameter group belongs to the first RRC parameter group set; the first message is transmitted via a sidelink SRB, while the first signaling is transmitted via an SRB, the SRB used for transmitting the first signaling being configured for the first cell group, the first cell group comprising at least one cell.

In one embodiment, the Q RRC parameter groups respectively correspond to Q cell groups; the first message is used to indicate a second cell group, the second cell group being used to determine a target cell group, and the first RRC parameter group being an RRC parameter group corresponding to the target cell group among the Q RRC parameter groups, where the target cell group is one of the Q cell groups; a cell group comprises at least one cell.

In one embodiment, when there is one and only cell group among the Q cell groups that comprises one cell in the second cell group, the target cell group is a cell group comprising the cell among the Q cell groups.

In one embodiment, when there are multiple cell groups among the Q cell groups that comprise at least one cell in the second cell group, the target cell group is a cell group among the multiple cell groups.

In one embodiment, the first transmitter 1102 transmits a third message;

herein, the third message is transmitted via the sidelink SRB, the third message indicating at least one cell belonging to both the second cell group and the target cell group.

In one embodiment, when any cell in the second cell group does not belong to the Q cell groups, the target cell group is the first cell group.

In one embodiment, when any cell in the second cell group does not belong to the Q cell groups, comprising:

as a response to receiving the first message, the first processor 1103 releasing the sidelink SRB.

In one embodiment, when any cell in the second cell group does not belong to the Q cell groups, the first receiver U1101 receives a first physical signal, the first physical signal being used for generating a first received quality, when the first received quality is greater than a first threshold, the first cell group is determined to be the target cell group.

In one embodiment, the first message is used for indicating whether a link of the first signaling is available.

In one embodiment, the first transmitter 1102 transmits a first report, the first report being used to indicate a PDCP SDU received via a link of the first signaling.

In one embodiment, the first node is a UE.

In one embodiment, the first node is a terminal supporting large delay difference.

In one embodiment, the first node is a terminal supporting NTN.

In one embodiment, the first node is an aircraft.

In one embodiment, the first node is a vehicle-mounted terminal.

In one embodiment, the first node is a relay.

In one embodiment, the first node is a vessel.

In one embodiment, the first node is an IoT terminal.

In one embodiment, the first node is an IIoT terminal.

In one embodiment, the first node is a piece of equipment supporting transmissions with low delay and high reliability.

In one embodiment, the first receiver 1101 comprises at least one of the antenna 452, the receiver 454, the receiving processor 456, the multi-antenna receiving processor 458, the controller/processor 459, the memory 460 or the data source 467 in Embodiment 4.

In one embodiment, the first transmitter 1102 comprises at least one of the antenna 452, the transmitter 454, the transmitting processor 468, the multi-antenna transmitting processor 457, the controller/processor 459, the memory 460 or the data source 467 in Embodiment 4.

### Embodiment 12

Embodiment 12 illustrates a structure block diagram of a processing device used in a second node according to one embodiment of the present application; as shown in FIG. 12. In FIG. 12, a processing device 1200 in a second node comprises a second transmitter 1201 and a second receiver 1202. In Embodiment 12,

the second transmitter 1201 transmits a first radio signal and a second radio signal; the first radio signal comprising a first signaling, and the second radio signal comprising a first message; the first signaling being used to indicate a first RRC parameter group set, the first RRC parameter group set comprising Q Radio Resource Control (RRC) parameter groups, Q being a positive integer greater than 1, while the first message being used to determine a first RRC parameter group from the first RRC parameter group set;

a receiver of the first signaling, executing a first RRC parameter group;

herein, the first RRC parameter group belongs to the first RRC parameter group set; the first message is transmitted via a sidelink SRB, while the first signaling is transmitted via an SRB, the SRB used for transmitting the first signaling being configured for the first cell group, the first cell group comprising at least one cell.

In one embodiment, the second receiver 1202 receives a first signaling, the first signaling being used for generating the first radio signal.

In one embodiment, the Q RRC parameter groups respectively correspond to Q cell groups; the first message is used to indicate a second cell group, the second cell group being used to determine a target cell group, and the first RRC parameter group being an RRC parameter group corresponding to the target cell group among the Q RRC parameter groups, where the target cell group is one of the Q cell groups; a cell group comprises at least one cell.

In one embodiment, when there is one and only cell group among the Q cell groups that comprises one cell in the second cell group, the target cell group is a cell group comprising the cell among the Q cell groups.

In one embodiment, when there are multiple cell groups among the Q cell groups that comprise at least one cell in the second cell group, the target cell group is a cell group among the multiple cell groups.

In one embodiment, the second receiver 1202: receiving a third message;

herein, the third message is transmitted via the sidelink SRB, the third message indicating at least one cell belonging to both the second cell group and the target cell group.

In one embodiment, when any cell in the second cell group does not belong to the Q cell groups, the target cell group is the first cell group.

In one embodiment, the first message is used for indicating whether a link of the first signaling is available.

In one embodiment, the second receiver 1202 receives a fourth message, the fourth message indicating a first RLC bearer and a first radio bearer, the first RLC bearer being associated with the first radio bearer, and the first RLC bearer being an RLC bearer of a Uu interface;

the third message is used for activating the first RLC bearer.

In one embodiment, the second receiver 1202 receives a second message; the second transmitter 1201 forwards the second message.

In one embodiment, the second node is a base station.

In one embodiment, the second node is a satellite.

In one embodiment, the second node is a UE.

In one embodiment, the second node is a Gateway.

In one embodiment, the second node is a base station supporting large delay difference.

In one embodiment, the second receiver 1202 comprises at least one of the antenna 452, the receiver 454, the receiving processor 456, the multi-antenna receiving processor 458, the controller/processor 459, the memory 460 or the data source 467 in Embodiment 4.

In one embodiment, the second transmitter 1201 comprises at least one of the antenna 452, the transmitter 454, the transmitting processor 468, the multi-antenna transmitting processor 457, the controller/processor 459, the memory 460 or the data source 467 in Embodiment 4.

### Embodiment 13

Embodiment 13 illustrates a structure block diagram of a processing device used in a third node according to one embodiment of the present application; as shown in FIG. 13. In FIG. 13, a processing device 1300 in a third node comprises a third transmitter 1301 and a third receiver 1302. In Embodiment 13,

the third transmitter 1301 transmits a first signaling; the first signaling being used to indicate a first RRC parameter group set, the first RRC parameter group set comprising Q RRC parameter groups, Q being a positive integer greater than 1;

a receiver of the first signaling, executing a first RRC parameter group; and

the third receiver 1302 receives a second message; the second message being used to determine that the first RRC parameter group is completed;

herein, the first RRC parameter group belongs to the first RRC parameter group set; the first signaling is transmitted via an SRB, the SRB used for transmitting the first signaling being configured for the first cell group, the first cell group comprising at least one cell.

In one embodiment, the Q RRC parameter groups respectively correspond to Q cell groups; the first message is used to indicate a second cell group, the second cell group being used to determine a target cell group, and the first RRC parameter group being an RRC parameter group corresponding to the target cell group among the Q RRC parameter groups, where the target cell group is one of the Q cell groups; a cell group comprises at least one cell.

In one embodiment, when there is one and only cell group among the Q cell groups that comprises one cell in the second cell group, the target cell group is a cell group comprising the cell among the Q cell groups.

In one embodiment, when there are multiple cell groups among the Q cell groups that comprise at least one cell in the second cell group, the target cell group is a cell group among the multiple cell groups.

In one embodiment, when any cell in the second cell group does not belong to the Q cell groups, the target cell group is the first cell group.

In one embodiment, the third transmitter 1301 transmits a first physical signal, the first physical signal being used for generating a first received quality, when any cell in the second cell group does not belong to the Q cell groups and when the first received quality is greater than a first threshold, the first cell group is determined to be the target cell group.

In one embodiment, the third receiver 1302 receives a first report, the first report being used to indicate a PDCP SDU received via a link of the first signaling.

In one embodiment, the third transmitter 1301 transmits a fourth message, the fourth message indicating a first RLC bearer and a first radio bearer, the first RLC bearer being associated with the first radio bearer, and the first RLC bearer being an RLC bearer of a Uu interface.

In one embodiment, the third transmitter 1301 transmits a first radio signal, the first radio signal comprising the first signaling.

In one embodiment, the third node is a base station.

In one embodiment, the third node is a satellite.

In one embodiment, the third node is a relay.

In one embodiment, the third node is a UE.

In one embodiment, the third node is a Gateway.

In one embodiment, the third node is a base station supporting large delay difference.

In one embodiment, the third transmitter 1301 comprises at least one of the antenna 420, the transmitter 418, the transmitting processor 416, the multi-antenna transmitting processor 471, the controller/processor 475 or the memory 476 in Embodiment 4.

In one embodiment, the third receiver 1302 comprises at least one of the antenna 420, the receiver 418, the receiving processor 470, the multi-antenna receiving processor 472, the controller/processor 475 or the memory 476 in Embodiment 4.

The ordinary skill in the art may understand that all or part of steps in the above method may be implemented by instructing related hardware through a program. The program may be stored in a computer readable storage medium, for example Read-Only-Memory (ROM), hard disk or compact disc, etc. Optionally, all or part of steps in the above embodiments also may be implemented by one or more integrated circuits. Correspondingly, each module unit in the above embodiment may be realized in the form of hardware, or in the form of software function modules. The present application is not limited to any combination of hardware and software in specific forms. The UE and terminal in the present application include but are not limited to unmanned aerial vehicles, communication modules on unmanned aerial vehicles, telecontrolled aircrafts, aircrafts, diminutive airplanes, mobile phones, tablet computers, notebooks, vehicle-mounted communication equipment, wireless sensor, network cards, terminals for Internet of Things (JOT), RFID terminals, NB-IOT terminals, Machine Type Communication (MTC) terminals, enhanced MTC (eMTC) terminals, data cards, low-cost mobile phones, low-cost tablet computers, satellite communication equipment, ship communication equipment, and NTN UE, etc. The base station or system device in the present application includes but is not limited to macro-cellular base stations, micro-cellular base stations, home base stations, relay base station, gNB (NR node B), Transmitter Receiver Point (TRP), NTN base station, satellite equipment and fight platform, and other radio communication equipment, eNB (LTE node B), test equipment like transceiving device simulating partial functions of base station or signaling tester.

The above are merely the preferred embodiments of the present application and are not intended to limit the scope of protection of the present application. Any modification, equivalent substitute and improvement made within the spirit and principle of the present application are intended to be included within the scope of protection of the present application.

What is claimed is:

1. A first node for wireless communications, comprising:
a first receiver, receiving a first radio signal and a second radio signal; the first radio signal comprising a first signaling, and the second radio signal comprising a first message; the first signaling being used to indicate a first RRC parameter group set, the first RRC parameter group set comprising Q Radio Resource Control (RRC) parameter groups, Q being a positive integer greater than 1, while the first message being used to determine a first RRC parameter group from the first RRC parameter group set;
a first processor, executing the first RRC parameter group; and
a first transmitter, transmitting a second message; the second message being used to determine that the first RRC parameter group is completed;
wherein the first RRC parameter group belongs to the first RRC parameter group set; the first message is transmitted via a sidelink Signaling Radio Bearer (SRB), while the first signaling is transmitted via an SRB, the SRB used for transmitting the first signaling is configured for a first cell group, the first cell group comprising at least one cell.

2. The first node according to claim 1, characterized in that the Q RRC parameter groups respectively correspond to Q cell groups; the first message is used to indicate a second cell group, the second cell group being used to determine a target cell group, and the first RRC parameter group being an RRC parameter group corresponding to the target cell group among the Q RRC parameter groups, where the target cell group is one of the Q cell groups; a cell group comprises at least one cell.

3. The first node according to claim 2, characterized in that when there is one and only cell group among the Q cell groups that comprises one cell in the second cell group, the target cell group is a cell group comprising the cell among the Q cell groups.

4. The first node according to claim 2, characterized in that when there are multiple cell groups among the Q cell groups that comprise at least one cell in the second cell group, the target cell group is a cell group among the multiple cell groups.

5. The first node according to claim 3, characterized in that when there are multiple cell groups among the Q cell groups that comprise at least one cell in the second cell group, the target cell group is a cell group among the multiple cell groups.

6. The first node according to claim 3, characterized in comprising:
the first transmitter, transmitting a third message;
wherein the third message is transmitted via the sidelink SRB, the third message indicating at least one cell belonging to both the second cell group and the target cell group.

7. The first node according to claim 5, characterized in comprising:
the first transmitter, transmitting a third message;
wherein the third message is transmitted via the sidelink SRB, the third message indicating at least one cell belonging to both the second cell group and the target cell group.

8. The first node according to claim 2, characterized in that when any cell in the second cell group does not belong to the Q cell groups, the target cell group is the first cell group.

9. The first node according to claim 3, characterized in that when any cell in the second cell group does not belong to the Q cell groups, the target cell group is the first cell group.

10. The first node according to claim 5, characterized in that when any cell in the second cell group does not belong to the Q cell groups, the target cell group is the first cell group.

11. The first node according to claim 10, characterized in comprising:
the first processor, as a response to receiving the first message, releasing the sidelink SRB;
wherein any cell in the second cell group does not belong to the Q cell groups.

12. The first node according to claim 1, characterized in that
each RRC parameter group among the Q RRC parameter groups comprises RRCReconfiguration.

13. The first node according to claim 1, characterized in that
each RRC parameter group among the Q RRC parameter groups comprises CellGroupConfig or radioBearerConfig.

14. The first node according to claim 1, characterized in that
the first message comprises a CellIdentity or a physicalCellld.

15. The first node according to claim 12, characterized in that
the first message indicates a serving cell change.

16. The first node according to claim 14, characterized in that
the first message indicates a serving cell change.

17. The first node according to claim 15, characterized in that
the first message indicates a SpCell change.

18. The first node according to claim 17, characterized in that
the first message is generated by MAC.

19. A third node for wireless communications, comprising:
a third transmitter, transmitting a first radio signal, the first radio signal comprising a first signaling; the first signaling being used to indicate a first RRC parameter group set, the first RRC parameter group set comprising Q RRC parameter groups, Q being a positive integer greater than 1;
a receiver of the first signaling, executing a first RRC parameter group; and
a third receiver, receiving a second message; the second message being used to determine that the first RRC parameter group is completed;
wherein the RRC parameter group belongs to the first RRC parameter group set; the first signaling is transmitted via an SRB, the SRB used for transmitting the first signaling being configured for the first cell group, the first cell group comprising at least one cell.

20. A method in a first node for wireless communications, comprising:
receiving a first radio signal and a second radio signal; the first radio signal comprising a first signaling, and the second radio signal comprising a first message; the first signaling being used to indicate a first RRC parameter group set, the first RRC parameter group set comprising Q Radio Resource Control (RRC) parameter groups, Q being a positive integer greater than 1, while the first message being used to determine a first RRC parameter group from the first RRC parameter group set;
executing the first RRC parameter group; and
transmitting a second message; the second message being used to determine that the first RRC parameter group is completed;
wherein the first RRC parameter group belongs to the first RRC parameter group set; the first message is transmitted via a sidelink Signaling Radio Bearer (SRB), while the first signaling is transmitted via an SRB, the SRB used for transmitting the first signaling is configured for a first cell group, the first cell group comprising at least one cell.
